(19) United States
(12) Patent Application Publication
(10) Pub. No.: US 2026/0237619 A1
(43) Pub. Date: Aug. 13, 2026

(54) MASS ANALYZER EVALUATION VIA SELF-BUNCHING COMPUTATION

(71) Applicant: Thermo Fisher Scientific (Bremen) GmbH, Bremen (DE)

(72) Inventors: Amelia Corinne Peterson, Aalen (DE); Konstantin Aizikov, Bremen (DE); Denis Chernyshev, Bremen (DE)

(21) Appl. No.: 19/052,912

(22) Filed: Feb. 13, 2025

(51) Int. Cl. H01J 49/00

(52) U.S. Cl. CPC H01J 49/0036; H01J 49/0009

(57) ABSTRACT

Systems/techniques are provided for facilitating mass analyzer evaluation via self-bunching computation. In various embodiments, a system can access a mass analyzer. In various instances, the system can separate an operational parameter space of the mass analyzer into a valid region and an invalid region, based on computing ion cloud self-bunching metrics at respective locations in the operational parameter space. In some cases, the system can perform a calibration protocol on the mass analyzer within the valid region and not within the invalid region. In other cases, the system can generate an alert in response to the valid region not matching a ground-truth valid region or in response to the invalid region not matching a ground-truth invalid region, wherein the alert can indicate that a manufacturing or supply change associated with the mass analyzer was not successful.

### BACKGROUND

Calibrating or otherwise evaluating the performance of a mass analyzer can be considered as a complicated or otherwise non-trivial task.

### SUMMARY

The following presents a summary to provide a basic understanding of one or more embodiments. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus or computer program products that facilitate mass analyzer evaluation via self-bunching computation are described.

According to one or more embodiments, a system is provided. The system can comprise a non-transitory computer-readable memory that can store computer-executable components. The system can further comprise a processor that can be operably coupled to the non-transitory computer-readable memory and that can execute the computer-executable components stored in the non-transitory computer-readable memory. In various embodiments, the computer-executable components can comprise an access component that can access a mass analyzer. In various aspects, the computer-executable components can comprise a bunching component that can separate an operational parameter space of the mass analyzer into a valid region and an invalid region, based on computing ion cloud self-bunching metrics at respective locations in the operational parameter space.

According to one or more embodiments, a computer-implemented method is provided. In various embodiments, the computer-implemented method can comprise accessing, by a device operatively coupled to a processor, a mass analyzer. In various aspects, the computer-implemented method can comprise separating, by the device, an operational parameter space of the mass analyzer into a valid region and an invalid region, based on computing ion cloud self-bunching metrics at respective locations in the operational parameter space.

According to one or more embodiments, a computer program product for facilitating mass analyzer evaluation via self-bunching computation is provided. In various embodiments, the computer program product can comprise a non-transitory computer-readable memory having program instructions embodied therewith. In various aspects, the program instructions can be executable by a processor to cause the processor to access a mass analyzer. In various instances, the program instructions can be executable to cause the processor to separate an operational parameter space of the mass analyzer into a valid region and an invalid region, based on computing ion cloud self-bunching metrics at respective locations in the operational parameter space.

### DESCRIPTION OF THE DRAWINGS

Various embodiments will be readily understood by the following detailed description in conjunction with the accompanying figures. To facilitate this description, like reference numerals designate like structural elements. Embodiments are illustrated by way of example, not by way of limitation, in the figures. The figures are not necessarily drawn to scale.

FIG. 1 illustrates an example, non-limiting block diagram of a scientific instrument module in accordance with various embodiments described herein.

FIG. 2 illustrates an example, non-limiting flow diagram of a computer-implemented method in accordance with various embodiments described herein.

FIG. 3 illustrates a block diagram of an example, non-limiting system that facilitates mass analyzer evaluation via self-bunching computation in accordance with one or more embodiments described herein.

FIG. 4 illustrates a block diagram of an example, non-limiting system including a self-bunching heat map that facilitates mass analyzer evaluation via self-bunching computation in accordance with one or more embodiments described herein.

FIGS. 5-9 illustrate example, non-limiting block diagrams showing how a self-bunching heatmap can be generated in accordance with one or more embodiments described herein.

FIG. 10 illustrates a block diagram of an example, non-limiting system including a calibration protocol or a manufacturing alert that facilitates mass analyzer evaluation via self-bunching computation in accordance with one or more embodiments described herein.

FIGS. 11-14 illustrate example, non-limiting experimental results in accordance with one or more embodiments described herein.

FIG. 15 illustrates a block diagram of an example, non-limiting operating environment in which one or more embodiments described herein can be facilitated.

FIG. 16 illustrates an example networking environment operable to execute various implementations described herein.

### DETAILED DESCRIPTION

The following detailed description is merely illustrative and is not intended to limit embodiments or application/uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details. It is also evident that new embodiments can be created by combining the embodiments described herein and/or by omitting certain features from the embodiments described therein, as appropriate.

Various operations can be described as multiple discrete actions or operations in turn, in a manner that is most helpful in understanding the subject matter disclosed herein. However, the order of description should not be construed as to imply that these operations are necessarily order dependent. In particular, these operations can be performed in an order different from the order of presentation. Operations described can be performed in a different order from the described embodiments. Various additional operations can be performed, or described operations can be omitted in additional embodiments.

Although some elements may be referred to in the singular (e.g., “a processing device”), any appropriate elements may be represented by multiple instances of that element, and vice versa. For example, a set of operations described as performed by a processing device may be implemented with different ones of the operations performed by different processing devices. As used herein, the phrase “based on” should be understood to mean “based at least in part on,” unless otherwise specified.

A mass spectrometer coupled to a chromatograph can be considered as a type of scientific instrument that can be deployed in a scientific, laboratory, research, or clinical operational context or setting, so as to determine the chemical composition or make-up of unknown samples. To facilitate such chemical composition determination, the mass spectrometer or chromatograph can comprise a complex arrangement of actuatable parts (e.g., ion sources, ion lenses, heaters, coolers, columns, ovens, injectors, mass analyzers, fluid valves, fluid pumps, circuit switches), sensors (e.g., ion detectors, voltmeters, thermistors, potentiometers, pressure gauges), or consumables (e.g., carrier fluids, calibrants, filters).

A mass analyzer can be considered as a particularly complicated constituent component of a mass spectrometer. A mass analyzer separates (or, in some cases, measures without physically separating) ions based on their mass-to-charge ratios (based on their m/z values), so that whatever chemical species make up a sample or specimen can be identified or quantified. Different mass analyzers exhibit different physical constructions, designs, or operating principles (e.g., quadrupole mass analyzers versus time-of-flight mass analyzers versus orbital trapping mass analyzers). In order for a mass analyzer to operate properly (e.g., to correctly, accurately, or reliably distinguish ions according to their mass-to-charge ratios), the mass analyzer should first be calibrated. In other words, whatever configurable operating parameters that the mass analyzer has should be set to or otherwise assigned whatever specific values that cause performance of the mass spectrometer to be optimized or approximately optimized.

Because the mass analyzer can have dozens of configurable operating parameters (e.g., electrode voltages, timing controls) that are not necessarily independent of each other, identification or determination of what specific parameter values that cause performance to be maximized can be considered as a difficult or otherwise non-trivial task. This difficulty or non-triviality is exacerbated by the fact that “performance” of the mass analyzer can be considered as an ephemeral concept which might be represented or proxied by any of various different metrics (e.g., Does optimizing “performance” mean obtaining an optimal resolution? Or does optimizing “performance” instead mean obtaining an optimal mass accuracy? Or does it instead mean obtaining an optimal ion transmission efficiency?). Such difficulty or non-triviality is even further exacerbated by the stochasticity of ion sources, by the stochasticity of mass spectrometry measurements, and by the fact that a change to any given configurable operating parameter might have opposing or conflicting influences on any given set of performance metrics (e.g., increasing the given configurable operating parameter might cause one performance metric to improve while simultaneously causing another performance metric to degrade). For at least these reasons, calibration protocols for mass analyzers are excessively computationally-expensive and time-consuming.

Accordingly, systems or techniques that can reduce the computational expense or time-consumption of mass analyzer calibration can be desirable.

Various embodiments described herein can address this technical problem. One or more embodiments described herein can include systems, computer-implemented methods, apparatus, or computer program products that can facilitate mass analyzer calibration (as well as other types of mass analyzer evaluation) via self-bunching computation. In particular, the inventors of various embodiments described herein realized that self-bunching can be leveraged as a screening tool to quickly and efficiently determine which regions within an operational parameter space of a mass analyzer are or are not likely to contain a properly calibrated configuration identifiable by a subsequent, computationally-expensive, time-consuming calibration protocol. Thus, the performance of such subsequent calibration protocol can be restricted only to whatever regions that such screening indicates are likely to contain the properly calibrated configuration. In this way, time and computing resources need not be wasted performing subsequent calibration protocols on regions that are unlikely to contain the properly calibration configuration.

More specifically, self-bunching is a scientific phenomenon in which ions of like charge moving through an electric or magnetic field produced by a mass analyzer (e.g., by a flight tube, orbital ion trap, or ion cyclotron resonator of the mass analyzer) attract or cohere to each other rather than repel each other. Self-bunching occurs in a given ion cloud when the population of (e.g., when the total number of ions within) that given ion cloud exceeds some threshold. In other words, when the population of an ion cloud within the mass analyzer becomes large enough, that ion cloud exhibits increased temporal stability by bunching together. Such increased temporal stability can be considered as counteracting ion decohering effects or ion dephasing effects which might otherwise be caused by complex space or image charge-related phenomena or field inhomogeneities associated with the mass analyzer. In other words, ion self-bunching can be considered as causing mass analyzer resolution to be limited only by ion scattering with residual gas molecules, as opposed to instead being limited both by ion scattering with residual gas molecules and by ion dephasing effects.

The present inventors recognized that the specific ion population at which self-bunching occurs within a given mass analyzer can depend upon the specific values of the operational parameters (e.g., electrode voltages, timing controls) of the mass analyzer. The present inventors further recognized that an ideal ion population at which self-bunching occurs can be identified empirically by examining mass analyzers that are known or deemed to be properly manufactured and calibrated. So, the present inventors realized that, for any given mass analyzer, a respective ion population at which self-bunching occurs can be identified or computed for each possible operational parameter configuration of the mass analyzer, and that a respective error between the ideal ion population and that identified or computed ion population can be calculated. Accordingly, subsequent calibration protocols (which can be highly accurate but also highly time-consuming or computationally expensive) can be performed only on whichever operational parameter configurations have sufficiently low self-bunching errors. In other words, the operational parameters of the given mass analyzer can be considered as forming a high-dimensional space through which those subsequent calibration protocols can search for a calibrated configuration, and the self-bunching errors can be used to quickly or efficiently shrink that high-dimensional space. In still other words, those subsequent calibration protocols need not waste any time or computing resources searching through operational parameter configurations that have excessively high self-bunching errors. This is because low self-bunching error can be considered as a necessary condition for calibration. That is, although it can be possible for an operational parameter configuration that has a low self-bunching error to not be a properly calibrated configuration, it can be highly improbable for an operational parameter configuration that has a high self-bunching error to be a properly calibrated configuration.

In this way, self-bunching computation can be leveraged as a screening tool to separate the operational parameter space of a mass analyzer into promising regions through which subsequent calibration protocols can search and unpromising regions through which subsequent calibration protocols need not search.

Various embodiments described herein can be considered as a computerized tool (e.g., any suitable combination of computer-executable hardware or computer-executable software) that can facilitate mass analyzer calibration via self-bunching computation. In various aspects, such computerized tool can comprise an access component, a bunching component, or an execution component.

In various embodiments, there can be a mass spectrometer, which may or may not be operatively coupled in any suitable fashion to a chromatograph. In various aspects, the mass spectrometer can comprise any suitable constituent hardware (e.g., any suitable ion beam emitter; any suitable ion detector; any suitable ion optics equipment). In various instances, such constituent hardware can include a mass analyzer exhibiting any suitable design, construction, or architecture (e.g., quadrupole mass filter analyzer, time-of-flight (TOF) analyzer, electrostatic trap or orbital trapping (e.g., ORBITRAP™) mass analyzer, or Fourier transform ion cyclotron resonance (FT-ICR) mass analyzer).

In various cases, the mass analyzer can have any suitable types of configurable operating parameters. In various aspects, a configurable operating parameter can be any suitable selectively-controllable hardware characteristic or selectively-controllable software characteristic of the mass analyzer that can be directly adjusted or changed in response to electronic instructions or commands received from a user. For example, such configurable operating parameters can include electrode voltages of the mass analyzer (e.g., voltages of end-cap electrodes, of ring electrodes, of plate electrodes, or of rod electrodes) or timing controls of the mass analyzer (e.g., an ion injection duration or an ion trapping duration).

In any case, it can be desired to calibrate the configurable operating parameters of the mass analyzer. In various instances, the computerized tool described herein can accomplish such calibration.

In various embodiments, the access component of the computerized tool can electronically access the mass spectrometer. That is, the access component can electronically interface with the mass spectrometer, such that any other components of the computerized tool can electronically interact with (e.g., send electronic commands to, read electronic signals from) the mass spectrometer and thus the mass analyzer.

In various embodiments, the bunching component of the computerized tool can electronically generate a self-bunching heatmap for the mass analyzer. In various aspects, the self-bunching heat map be considered as a multi-dimensional graph, plot, or chart whose independent variables are the operating parameters of the mass analyzer and whose dependent variable is a self-bunching error. More specifically, the self-bunching heatmap can contain a plurality of operating parameter configurations and a respectively corresponding plurality of self-bunching errors. In various instances, each of the plurality of operating parameter configurations can be considered as a distinct or unique collection, set, or group of specific values which can be taken on by the operating parameters of the mass analyzer. In other words, the plurality of operating parameter configurations can be considered as discretely spanning the continuous domain or space of values that can possibly be assigned to the operating parameters of the mass analyzer (e.g., as discretely spanning the continuous domain or space of voltage values or timing control values that can be implemented by the mass analyzer). In various cases, each of the plurality of self-bunching errors can be a scalar indicating a difference between: an ion population at which self-bunching occurs when the mass analyzer is set according to a respective one of the plurality of operating parameter configurations; and an ideal or ground-truth ion population at which self-bunching is desired to occur.

In various aspects, the bunching component can generate the self-bunching heat map by causing the mass analyzer to perform a respective quick or low-resolution scan using each of the plurality of operating parameter configurations.

As a non-limiting example, consider any given one of the plurality of operating parameter configurations. In various instances, the bunching component can instruct or command the mass spectrometer to perform a scan (e.g., on any suitable specimen or sample) using the given operating parameter configuration. In other words, the bunching component can cause the operating parameters (e.g., the electrode voltages, the timing controls) of the mass analyzer to take on or otherwise be set to whatever particular values are specified in the given operating parameter configuration. With the operating parameters being set to the particular values specified in the given operating parameter configuration, the bunching component can then cause the mass spectrometer to perform a scan. Note that such scan can consume very little time (e.g., on the order of mere milliseconds). In any case, such scan can yield a mass spectrum. In various aspects, the mass spectrum can be considered as a graph, plot, or chart of relative ion abundance recorded by the mass spectrometer during the scan as a function of mass-to-charge ratio. In various instances, the mass spectrum can exhibit any suitable number of peaks. In various cases, the bunching component can generate an intermediate graph, plot, or chart, by computing a respective ion population and a respective ion cloud decay rate for each peak in the mass spectrum. In particular, the intermediate graph, plot, or chart can show ion cloud decay rate as a function of ion population. Note that any suitable proxies for ion cloud decay rate or ion population can be used or implemented (e.g., normalized resolution of each peak can be used as a proxy for ion cloud decay rate of each peak; signal-to-noise ratio of each peak can be used as a proxy for ion population of each peak). In various aspects, the bunching component can fit an exponential plateau function to the intermediate graph, plot, or chart, and the bunching component can utilize that fitted exponential plateau function to identify a self-bunching metric for the given operating parameter configuration, where the self-bunching metric can be whatever specific ion population or proxy thereof at which self-bunching seems to occur when the mass analyzer is set to the given operating parameter configuration. For instance, the fitted exponential plateau function can have a supremum or upper asymptote, and the self-bunching metric can be equal to whatever ion population or proxy which causes the fitted exponential decay function to achieve any suitable percentage (e.g., 95%) of that supremum or upper asymptote. In various cases, the bunching component can compute a self-bunching error for the given operating parameter configuration, by comparing the self-bunching metric to a ground-truth or ideal self-bunching metric. For instance, the self-bunching error can be equal to an absolute value of a difference between the self-bunching metric and the ground-truth or ideal self-bunching metric.

By repeating the above-described actions for each of the plurality of operating parameter configurations, the bunching component can incrementally build the self-bunching heatmap. Note that the bunching component can consume a total of mere seconds or minutes to generate the self-bunching heatmap, since the most time-consuming action involved in such generation (e.g., causing the mass spectrometer to perform a scan) can consume mere milliseconds for each operating parameter configuration.

In any case, the bunching component can separate or divide the operating parameter space or domain of the mass analyzer into one or more valid regions and one or more invalid regions, based on the self-bunching heat map. In particular, the operating parameter space or domain can be spanned by the plurality of operating parameter configurations, and the self-bunching heatmap can specify a respective self-bunching error for each of the plurality of operating parameter configurations. In various aspects, the bunching component can label as “valid” any operating parameter configuration whose self-bunching error is below any suitable threshold. In contrast, the bunching component can instead label as “invalid” any operating parameter configuration whose self-bunching error is above that threshold. In various instances, a “valid” operating parameter configuration can be considered as one which causes the mass analyzer to exhibit a self-bunching metric that is close to the ground-truth or ideal self-bunching metric and thus might potentially be a properly calibrated configuration. On the other hand, an “invalid” operating parameter configuration can be considered as one which causes the mass analyzer to exhibit a self-bunching metric that is far from the ground-truth or ideal self-bunching metric and thus cannot be a properly calibrated configuration. Note that self-bunching error can be considered as varying stably or non-chaotically with operating parameter configuration. In other words, small changes to the specific values of the operating parameters can elicit commensurately small changes in the resultant self-bunching error. This stable or non-chaotic behavior can cause valid operating parameter configurations to cluster together within the operating parameter space or domain and can likewise cause invalid operating parameter configurations to cluster together within the operating parameter space or domain. In various aspects, each cluster of valid operating parameter configurations can be considered as being or forming a respective valid region within the operating parameter space or domain. Conversely, each cluster of invalid operating parameter configurations can be considered as being or forming a respective invalid region within the operating parameter space or domain.

In various embodiments, the execution component of the computerized tool can electronically perform a calibration protocol on the mass analyzer within the one or more valid regions and not within the one or more invalid regions. More specifically, the one or more valid regions of the operating parameter space or domain can be considered as being promising regions within which a properly calibrated configuration is likely to be found. That is, the one or more valid regions can be considered as having a high likelihood of being fruitful from a calibration perspective. After all, whatever properly calibrated configuration that is ultimately identified for the mass analyzer must correspond to a self-bunching metric that is close to the ground-truth or ideal self-bunching metric, and the configurations that fall inside the one or more valid regions exhibit such a metric. In contrast, the one or more invalid regions of the operating parameter space or domain can be considered as not being promising regions within which the properly calibrated configuration is likely to be found. That is, the one or more invalid regions can be considered as having a low likelihood of being fruitful from a calibration perspective. After all, whatever properly calibrated configuration that is ultimately identified for the mass analyzer must correspond to a self-bunching metric that is close to the ground-truth or ideal self-bunching metric, but the configurations that fall inside the one or more invalid regions fail to exhibit such a metric. Accordingly, whatever sensitive-but-expensive calibration protocol that is desired to be performed on the mass analyzer can be performed within the one or more valid regions and not within the one or more invalid regions. In other words, time and computing resources need not be wasted searching through the one or more invalid regions for the properly calibrated configuration. In this way, the execution component can be considered as screening the operating parameter space or domain using the self-bunching heatmap, so that the total time or computational expense consumed by the calibration protocol can be lower than it otherwise would be without such screening.

In some embodiments, the self-bunching heatmap can be leveraged for purposes other than calibration of the mass analyzer. As a non-limiting example, suppose that the particular instantiation of the mass analyzer for which the self-bunching heatmap is generated was fabricated using an experimental manufacturing process or using newly-sourced building materials. In such case, the execution component can utilize the self-bunching heatmap to determine whether or not the experimental manufacturing process or the newly-sourced building materials are acceptable. For instance, the execution component can compare the self-bunching heatmap to a ground-truth or ideal self-bunching heatmap that is known or deemed to correspond to a properly fabricated instantiation of the mass analyzer. In various cases, the execution component can facilitate such comparison via any suitable data processing technique (e.g., via cosine similarity computation, via Euclidean distance computation, via cross-entropy error computation, via artificial intelligence). In any of such situations, the execution component can conclude or determine that the experimental manufacturing process or newly-sourced building materials are not acceptable, in response to the self-bunching heat map being too different from the ground-truth or ideal self-bunching heat map. In other words, if the experimental manufacturing process or the newly-sourced building materials cause the valid regions or invalid regions within the operating parameter space or domain of the mass analyzer to significantly change, the execution component can infer that something is wrong or otherwise concerning with the experimental manufacturing process or the newly-sourced building materials. In such case, the execution component can electronically generate any suitable alert, warning, or message indicating such inference.

Various embodiments described herein can be employed to use hardware or software to solve problems that are highly technical in nature (e.g., to facilitate mass analyzer calibration or broader evaluation via self-bunching computation), that are not abstract and that cannot be performed as a set of mental acts by a human. Further, some of the processes performed can be performed by a specialized computer (e.g., mass spectrometers coupled to liquid, gas, or ion chromatographs) for carrying out defined acts related to the field of mass analyzer calibration.

For example, such defined acts can include: accessing, by a device operatively coupled to a processor, a mass analyzer; and separating, by the device, an operational parameter space of the mass analyzer into a valid region and an invalid region, based on computing ion cloud self-bunching metrics at respective locations in the operational parameter space. In some aspects, such defined acts can further include: performing, by the device, a calibration protocol on the mass analyzer within the valid region and not within the invalid region; or generating, by the device, an alert in response to the valid region not matching a ground-truth valid region or in response to the invalid region not matching a ground-truth invalid region, wherein the alert indicates that a manufacturing or supply change associated with the mass analyzer was not successful. In some instances, the separating can include: causing, by the device and for a first location within the operational parameter space, the mass analyzer to perform a scan, thereby yielding a first mass spectrum that shows relative ion abundance as a function of mass-to-charge ratio; computing, by the device and for each peak in the first mass spectrum, a respective ion cloud decay rate or proxy thereof and a respective ion population or proxy thereof, thereby yielding a first intermediate plot; identifying, by the device, a first ion cloud self-bunching metric for the first location in the operational parameter space, based on fitting an exponential plateau function to the first intermediate plot; computing, by the device, a first loss between the first ion cloud self-bunching metric and an ideal ion cloud self-bunching metric; labeling, by the device, the first location in the operational parameter space as valid, in response to the first loss falling below a threshold value; or labeling, by the device, the first location in the operational parameter space as invalid, in response to the first loss exceeding the threshold value.

Such defined acts are inherently computerized. Indeed, a mass spectrometer is a highly-technical computerized device comprising specific computerized hardware (e.g., temperature sensors, pressure sensors, voltage sensors, ion beam emitters, electron beam emitters, focusing lenses, ion detectors, electron detectors, beam apertures, fluid valves). A mass spectrometer, the operations that it performs, and the mass spectra that it captures cannot be implemented by the human mind, or by a human with mere pen and paper, in any reasonable or practicable way without computers. Furthermore, a mass analyzer is a specific, tangible constituent piece of hardware in various scientific instruments that separates, arranges, orders, measures, or otherwise distinguishes ions according to mass-to-charge ratio. A mass analyzer and the ion-distinguishing functionality that it performs cannot be implemented in any way whatsoever by the human mind or by a human with mere pen and paper.

Moreover, various embodiments described herein can integrate into a practical application various teachings relating to the field of mass analyzer calibration. As explained above, in order for a mass analyzer to properly, accurately, or correctly distinguish ions according to mass-to-charge ratio, the mass analyzer must first be calibrated. Because the mass analyzer can have a plethora of operating parameters (e.g., dozens of distinct types of electrode voltages or timing controls) each of which can range across a respective domain or interval of possible values, the mass analyzer can be considered as having a high-dimensional operating parameter space, and the act of calibrating the mass analyzer can be considered as searching through that high-dimensional operating parameter space for one specific combination of values that causes the mass analyzer to achieve a desired performance. Due to the high dimensionality of the operating parameter space, such searching can consume massive amounts of time or computing resources (e.g., hours spent on calibration).

Various embodiments described herein can help to ameliorate this technical problem. In particular, various embodiments described herein can leverage ion cloud self-bunching computations in order to quickly, efficiently, or otherwise inexpensively screen the operating parameter space for promising regions that are likely to contain the one specific combination of values that would cause the mass analyzer to achieve the desired performance. More specifically, ion cloud self-bunching can be considered as a phenomenon that occurs when the ion population within the mass analyzer reaches some threshold size. That threshold size can vary depending upon the specific operating parameter values implemented by the mass analyzer. In various aspects, the operating parameter space can be discretely spanned by a collection of operating parameter configurations, each configuration being a specific combination of operating parameter values (e.g., being a specific location within the operating parameter space) that could potentially be implemented by the mass analyzer. In various instances, a respective ion population at which ion cloud self-bunching occurs can be computed or calculated for each of those operating parameter configurations. This can be accomplished by: causing the mass analyzer to perform a scan using a given operating parameter configuration, thereby yielding a resultant mass spectrum; computing for each peak in the resultant mass spectrum a respective ion population and a respective ion cloud decay rate (or proxies thereof), thereby yielding an intermediary plot showing ion cloud decay rate as a function of ion population; and fitting an exponential plateau function to the intermediary plot, wherein the ion population at which ion cloud self-bunching occurs is whichever ion population is linked by that fitted exponential plateau function to a horizontal asymptote (or percentage thereof) of the fitted exponential plateau function. In various cases, any operating parameter configuration that causes ion cloud self-bunching to occur at or near any suitable ideal or ground-truth ion population can be considered as being a possible candidate for calibration (e.g., whatever properly calibrated operating parameter configuration is ultimately chosen for the mass analyzer will necessarily cause ion cloud self-bunching to occur at or near the ideal or ground-truth ion population). In contrast, any operating parameter configuration that causes ion cloud self-bunching to occur far from the ideal or ground-truth ion population can be considered as not being a possible candidate for calibration (e.g., an operating parameter configuration that causes ion cloud self-bunching to occur far from the ideal or ground-truth ion population cannot possibly be the properly calibrated operating parameter configuration which is ultimately chosen for the mass analyzer). By computing ion populations at which ion cloud self-bunching occurs for respective locations throughout the operating parameter space of the mass analyzer, the operating parameter space can be considered as being separated into valid regions and invalid regions, where the valid regions are clusters of operating parameter configurations whose self-bunching populations are close to the ideal or ground-truth population, and where the invalid regions are clusters of operating parameter configurations whose self-bunching populations are far from the ideal or ground-truth population. Accordingly, any time-consuming or resource-intensive calibration protocols that are subsequently performed for the mass analyzer can be performed on or with respect to the valid regions and can be not performed on or with respect to the invalid regions. In other words, the valid regions can be considered as “worth searching through for calibration purposes,” whereas the invalid regions can be considered as “not worth searching through for calibration purposes.” Thus, no time or resources need be wasted by the subsequent calibration protocols on or with respect to the invalid regions. Stated differently, various embodiments described herein utilize ion cloud self-bunching as a screening tool to quickly and easily shrink the high-dimensional operating parameter space of the mass analyzer, so that subsequent calibration efforts can be focused on the shrunken operating parameter space rather than on the entire operating parameter space. In this way, a total amount of calibration time-consumption or resource-consumption for the mass analyzer can be reduced.

Furthermore, it must be emphasized how counterintuitive various embodiments described herein are. Indeed, various embodiments described herein can be considered as a highly unusual, strange, creative, or unexpected application or utilization of ion cloud self-bunching. After all, ion cloud self-bunching has been conventionally utilized only for the measurement of certain material properties of samples or specimens of interest, such as collisional cross-sections or isotopic ratios. Prior to the herein-described embodiments devised by the present inventors, there was never any indication that ion cloud self-bunching could serve as a quick or efficient screening tool for shrinking the high-dimensional operating parameter space of mass analyzers so as to reduce the expense of calibration. In other words, a person or ordinary skill in the art who wanted to reduce the expense of mass analyzer calibration would have had no reason whatsoever to investigate whether such reduction could be accomplished by somehow leveraging ion cloud self-bunching computations prior to calibration protocols. Instead, such person of ordinary skill would have tried to improve the calibration protocols themselves. Thus, various embodiments described herein can be considered as a clever use of ion cloud self-bunching.

For at least the above reasons, various embodiments described herein can be considered as addressing or ameliorating various technical problems or disadvantages that plague existing techniques. Therefore, various embodiments described herein can be considered as a concrete and tangible technical improvement in the field of mass analyzer calibration. Accordingly, various embodiments described herein certainly qualify as useful and practical applications of computers.

Furthermore, various embodiments described herein can control real-world tangible devices based on the disclosed teachings. For example, various embodiments described herein can electronically activate, deactivate, or otherwise actuate real-world hardware (e.g., electrodes) of real-world mass analyzers.

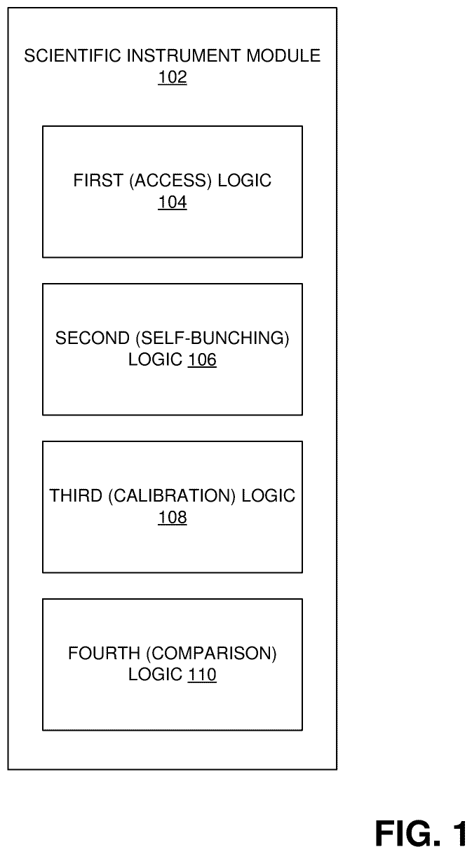

FIG. 1 illustrates an example, non-limiting block diagram of a scientific instrument module 102 in accordance with various embodiments described herein.

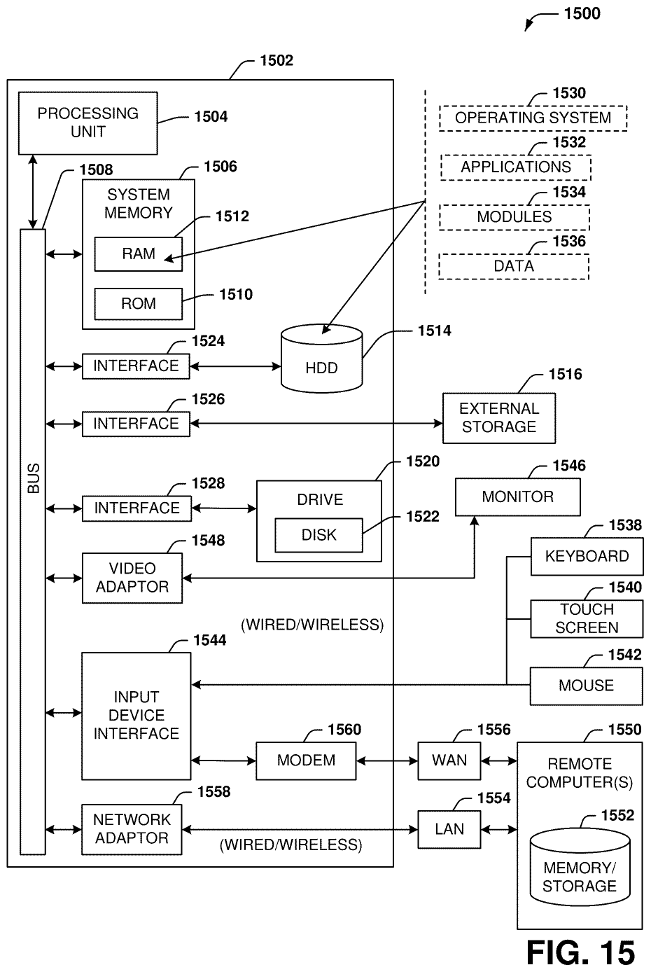

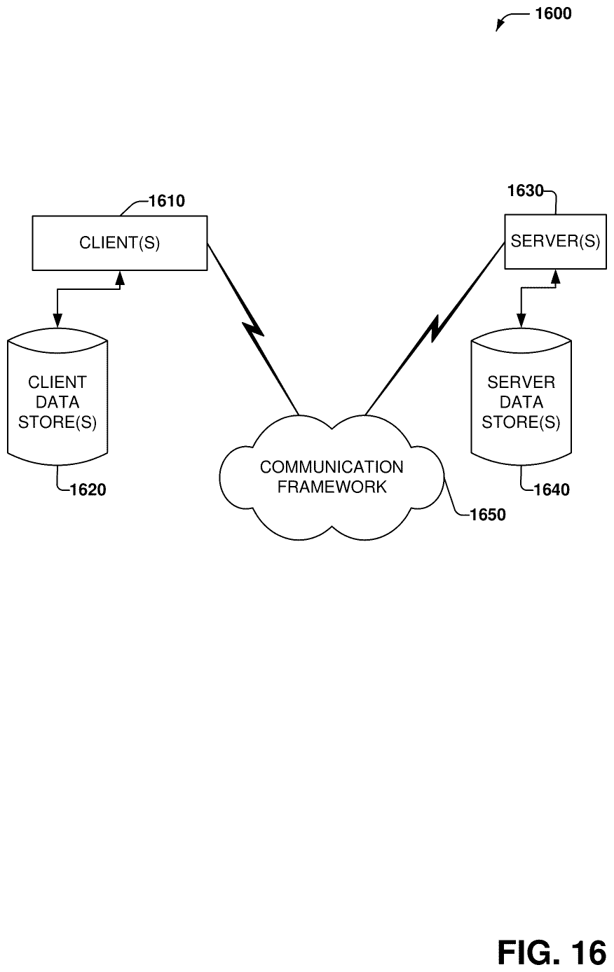

In various embodiments, the scientific instrument module 102 can be implemented by circuitry (e.g., including electrical or optical components), such as a programmed computing device. Logic of the scientific instrument module 102 can be included in a single computing device or can be distributed across multiple computing devices that are in communication with each other as appropriate. Examples of computing devices that may, singly or in combination, implement the scientific instrument module 102 are discussed herein with reference to FIG. 15, and examples of systems or networks of interconnected computing devices, in which the scientific instrument module 102 may be implemented across one or more of the computing devices, are discussed herein with reference to FIG. 16.

The scientific instrument module 102 can include first logic 104, second logic 106, third logic 108, or fourth logic 110. As used herein, the term “logic” can include an apparatus that is to perform a set of operations associated with the logic. For example, any of the logic elements included in the scientific instrument module 102 can be implemented by one or more computing devices programmed with instructions to cause one or more processing devices of the computing devices to perform the associated set of operations. In a particular embodiment, a logic element may include one or more non-transitory computer-readable media having instructions thereon that, when executed by one or more processing devices of one or more computing devices, cause the one or more computing devices to perform the associated set of operations. As used herein, the term “module” can refer to a collection of one or more logic elements that, together, perform a function associated with the module. Different ones of the logic elements in a module may take the same form or may take different forms. For example, some logic in a module may be implemented by a programmed general-purpose processing device, while other logic in a module may be implemented by an application-specific integrated circuit (ASIC). In another example, different ones of the logic elements in a module may be associated with different sets of instructions executed by one or more processing devices. A module can omit one or more of the logic elements depicted in the associated drawings; for example, a module may include a subset of the logic elements depicted in the associated drawings when that module is to perform a subset of the operations discussed herein with reference to that module.

In various embodiments, there can be a scientific instrument corresponding to the scientific instrument module 102. In various aspects, the scientific instrument can be any suitable computerized device that can electronically measure some scientifically-relevant, clinically-relevant, or research-relevant characteristic, property, or attribute of an analytical specimen (e.g., of a known or unknown mixture, compound, or collection of matter). As a non-limiting example, a scientific instrument can be a scanning electron microscope. In such case, the scientific instrument can measure or determine a surface topography of the analytical specimen. As another non-limiting example, a scientific instrument can be a transmission electron microscope. In such case, the scientific instrument can measure or determine internal structural details of the analytical specimen. As yet another non-limiting example, a scientific instrument can be an electron energy-loss microscope. In such case, the scientific instrument can measure or determine location-wise counts or intensities across a range of defined energy-loss bins or bands for the analytical specimen. As a more general non-limiting example, a scientific instrument can be any suitable type of charged-particle microscope (e.g., some types of microscopes can use beams of non-electron ions to capture images or energy spectra or to otherwise interact with specimens). As another non-limiting example, a scientific instrument can be a mass spectrometer that is operatively coupled to a chromatograph. In such case, the scientific instrument can measure or determine chromatograms (e.g., relative compound abundance as a function of retention time) or ion spectra (e.g., relative ion abundance as a function of mass-to-charge ratio) of the analytical sample. In any of such situations, the scientific instrument can include or otherwise contain a mass analyzer.

In various embodiments, the first logic 104 can involve accessing or otherwise establishing electronic communication with the mass analyzer.

In various embodiments, the second logic 106 can involve separating an operational parameter space of the mass analyzer into a valid region and an invalid region, based on computing ion cloud self-bunching metrics at respective locations with the operational parameter space. In particular, the second logic 106 can include discretizing the operational parameter space into a plurality of operational parameter configurations. Each operational parameter configuration can be considered as a unique combination of values that the operational parameters of the mass analyzer could be assigned, and thus each operational parameter configuration can be considered as a distinct location within the operational parameter space. In various aspects, the second logic 106 can include causing the mass analyzer to perform a respective scan using each of plurality of operational parameter configurations, with each scan producing a respective mass spectrum. For any given operational parameter configuration, the second logic 106 can include computing a respective ion population and a respective ion cloud decay rate (or proxies thereof) for each peak within the mass spectrum corresponding to that given operational parameter configuration. Thus, the given operational parameter configuration can be considered as having given rise to a plot showing ion cloud decay rate as a function of ion population. In various instances, the second logic 106 can include fitting an exponential plateau function to that plot and leveraging that fitted function to identify the ion population at which self-bunching occurs for the given operational parameter configuration. In various cases, the second logic 106 can include computing an error or loss between the ion population at which self-bunching occurs for the given operational parameter configuration and a ground-truth or ideal ion population at which self-bunching is desired to occur. In this way, each distinct location within the operational parameter space can be considered as having a respective self-bunching error or loss value. In various aspects, any location within the operational parameter space that has a self-bunching error or loss value that is below any suitable threshold can be classified as belonging to the valid region. In contrast, any location within the operational parameter space that has a self-bunching error or loss value that is above the threshold can be classified as belonging to the invalid region.

In various embodiments, the third logic 108 can involve conducting a calibration protocol on the mass analyzer within the valid region and not within the invalid region. In this way, a total amount of time or computing resources consumed by the calibration protocol can be reduced, as compared to a situation in which the calibration protocol is instead conducted on the entire operational parameter space.

In various embodiments, the fourth logic 110 can involve generating an alert in response to the valid region not matching a ground-truth valid region or in response to the invalid region not matching a ground-truth invalid region, wherein the alert can indicate that a manufacturing or supply change associated with the mass analyzer was not successful. In other words, separating the operational parameter space into valid and invalid regions based on ion cloud self-bunching computations can be useful for purposes other than calibration (e.g., can be useful to determine whether or not a new manufacturing process or a new raw material supplier associated with fabrication of the mass analyzer is successful or appropriate).

Accordingly, the scientific instrument module 102 can facilitate mass analyzer calibration, or even broader evaluation, via self-bunching computation.

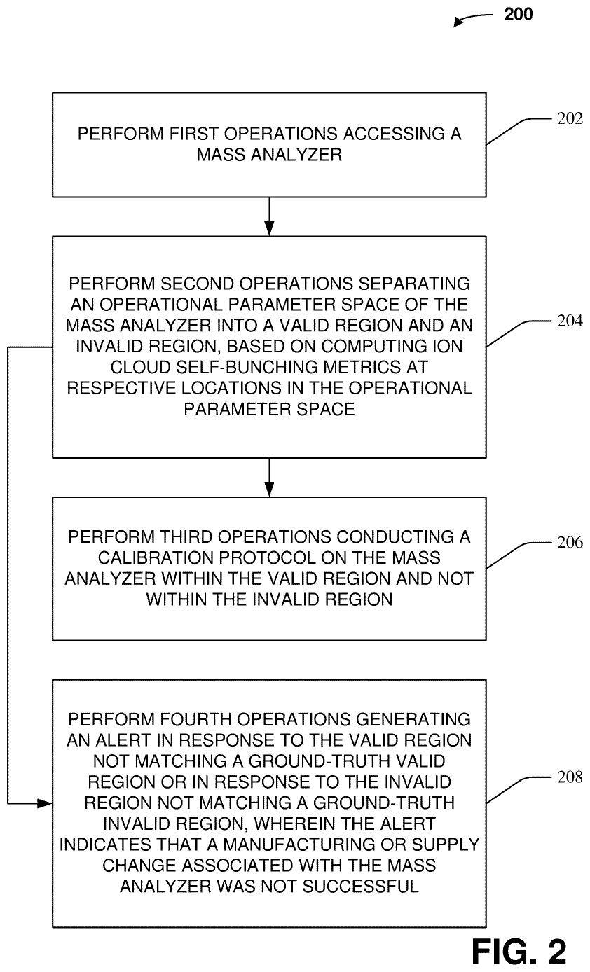

FIG. 2 is an example, non-limiting flow diagram of a computer-implemented method 200 in accordance with various embodiments described herein. The operations of the computer-implemented method 200 may be used in any suitable context to perform any suitable operations (e.g., can be performed by or used in conjunction with any of the various modules, computing devices, or graphical user interfaces described with respect to of FIGS. 1, 15, and 16). Operations are illustrated once each and in a particular order in FIG. 2, but the operations may be reordered or repeated as desired and appropriate (e.g., different operations performed may be performed in parallel, as suitable).

In various aspects, act 202 can include performing first operations accessing a mass analyzer. In various cases, the first logic 104 can perform or otherwise facilitate act 202.

In various aspects, act 204 can include performing second operations separating an operational parameter space of the mass analyzer into a valid region and an invalid region, based on computing ion cloud self-bunching metrics at respective locations in the operational parameter space. In various instances, the second logic 106 can perform or otherwise facilitate act 204. In some cases, act 204 can lead to act 206. In other cases, act 204 can lead to act 208.

In various aspects, act 206 can include performing third operations conducting a calibration protocol on the mass analyzer within the valid region and not within the invalid region.

In various instances, act 208 can include generating an alert in response to the valid region not matching a ground-truth valid region or in response to the invalid region not matching a ground-truth invalid region, wherein the alert indicates that a manufacturing or supply change associated with the mass analyzer was not successful.

Accordingly, the computer-implemented method 200 can facilitate mass analyzer calibration, or even broader evaluation, via self-bunching computation.

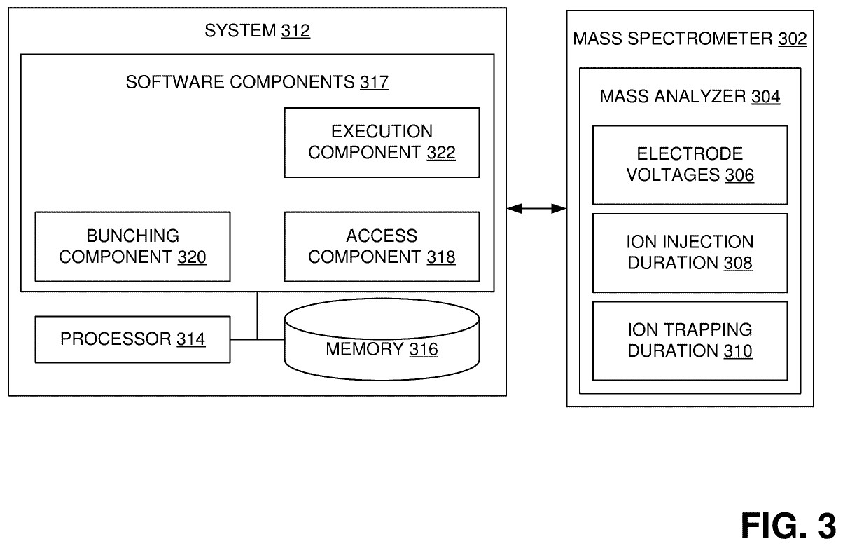

FIG. 3 illustrates a block diagram of an example, non-limiting system that can facilitate mass analyzer calibration or evaluation via self-bunching computation in accordance with one or more embodiments described herein.

In various embodiments, there can be a mass spectrometer 302. In various aspects, the mass spectrometer 302 can be any suitable type of mass spectrometer exhibiting any suitable design or construction for measuring ion spectra of analytical samples. In various instances, the mass spectrometer 302 can be made up of any suitable constituent hardware. As a non-limiting example, the mass spectrometer 302 can include any suitable ion source or ion beam emitter, such as a matrix assisted laser desorption/ionization (MALDI) source, electrospray ionization (ESI) source, atmospheric pressure chemical ionization (APCI) source, atmospheric pressure photoionization (APPI) source, or inductively coupled plasma (ICP) source. As another non-limiting example, the mass spectrometer 302 can include any suitable ion detectors, such as electron multiplier detectors, microchannel plate detectors, image charge detectors, or Faraday cup detectors. As even another non-limiting example, the mass spectrometer 302 can include any suitable ion optics equipment, such as ion focusing lenses, ion guides, or ion deflectors. In some instances, the mass spectrometer 302 can be any suitable type of Fourier transform mass spectrometer.

In various cases, one of the pieces of constituent hardware that make up the mass spectrometer 302 can be a mass analyzer 304. In various aspects, the mass analyzer 304 can exhibit any suitable design or construction that can physically separate (or, in some instances, otherwise distinguish without physically separating) ions according to their mass-to-charge ratios. As a non-limiting example, the mass analyzer 304 can be any suitable type of quadrupole filter mass analyzer. As another non-limiting example, the mass analyzer 304 can be any suitable type of time-of-flight mass analyzer. As yet another non-limiting example, the mass analyzer 304 can be any suitable type of orbital trapping mass analyzer. As still another non-limiting example, the mass analyzer 304 can be any suitable type of Fourier transform ion cyclotron resonance mass analyzer. As even another non-limiting example, the mass analyzer 304 can be any suitable type of magnetic sector mass analyzer.

No matter its particular design or construction, the mass analyzer 304 can be considered as having any suitable number of any suitable types of configurable operating parameters. In various aspects, a configurable operating parameter can be any suitable hardware-related characteristic or software-related characteristic of the mass analyzer 304 that can guide, affect, or otherwise dictate how the mass analyzer 304 physically separates or otherwise distinguishes ions according to mass-to-charge ratio and that can be selectively controlled, changed, adjusted, or otherwise set (e.g., by a user of the mass spectrometer 302 or automatically).

In some cases, such configurable operating parameters can include one or more electrode voltages 306 of the mass analyzer 304. Indeed, the mass analyzer 304 can have or be made up of one or more electrodes. As a non-limiting example, a quadrupole mass analyzer can have four rod electrodes arranged in parallel pairs which, when driven by applied voltages, create an electric field that filters passing ions according to mass-to-charge ratio. As another non-limiting example, a quadrupole ion trap or linear ion trap mass analyzer can have an ion trap that is sandwiched between various endcap electrodes and or ring electrodes, and driving such electrodes with applied voltages can create an oscillating electric field that can trap and selectively eject ions from a three-dimensional or one-dimensional trapping region based on mass-to-charge ratio. As yet another non-limiting example, a time-of-flight mass analyzer can have repeller electrodes that divert ions from an ion source toward a flight tube, accelerator electrodes that speed up the ions in the flight tube, and drift electrodes that help steer the paths of the ions within the flight tube, where the amount of time it takes for a given ion to traverse the flight tube indicates mass-to-charge ratio. As still another non-limiting example, an orbital trapping mass analyzer can have a spindle electrode surrounded by split outer electrodes, such that driving those electrodes via applied voltages causes ions to orbit the spindle electrode, and such that the orbital characteristics (e.g., period) of a given ion indicates its mass-to-charge ratio. In any case, the mass analyzer 304 can have one or more electrodes, and the configurable, controllable, or selectable voltages of those one or more electrodes can be referred to as the one or more electrode voltages 306. In various instances, each of the one or more electrode voltages 306 can be a scalar measured in any suitable units of voltage (e.g., volts, kilovolts, millivolts).

In some cases, the configurable operating parameters of the mass analyzer 304 can include an ion injection duration 308. In various aspects, the ion injection duration 308 can be a configurable, controllable, or selectable amount of time during which the mass analyzer 304 permits ions emitted from an ion source of the mass spectrometer 302 to enter the mass analyzer 304. The longer the ion injection duration 308 is, the more ions that are permitted to enter the mass analyzer 304 during any suitable scan, which can help to increase signal-to-noise ratios of any resulting mass spectra. In various instances, the ion injection duration 308 can be a scalar measured in any suitable units of time (e.g., seconds, milliseconds, microseconds).

In some cases, the configurable operating parameters of the mass analyzer 304 can include an ion trapping duration 310. In various aspects, the ion trapping duration 310 can be a configurable, controllable, or selectable amount of time during which the mass analyzer 304 traps or confines ions to any suitable defined subregion of the mass analyzer 304 (e.g., trapped in a volume bounded by endcap and ring electrodes; trapped in a volume surrounding a spindle electrode and bounded by split outer electrodes). In some cases, the longer the ion trapping duration 310 is, the higher the sensitivity of the mass analyzer 304, but the greater the likelihood of resolution reduction or inter-ion reactions. But in other cases (e.g., for orbital trapping mass analyzers), the longer the ion trapping duration 310, the higher the resolution (assuming adequately low pressure). In various instances, the ion trapping duration 310 can be a scalar measured in any suitable units of time (e.g., seconds, milliseconds, microseconds).

It should be understood or otherwise appreciated that the mass analyzer 304 can have any other suitable types of configurable operating parameters. The one or more electrode voltages 306, the ion injection duration 308, and the ion trapping duration 310 are mere non-limiting examples. For instance, any other suitable type of timing control can be considered as a configurable operating parameter of the mass analyzer 304, such as a time between ion ejections, or such as respective ramping times for the one or more electrode voltages 306.

In any case, the mass analyzer 304 can currently or presently be uncalibrated. In other words, whatever specific values are currently or presently assigned to the one or more electrode voltages 306, to the ion injection duration 308, or the ion trapping duration 310 can cause the mass analyzer 304 to not properly or reliably separate or distinguish ions according to mass-to-charge ratio. Thus, it can be desired to calibrate the mass analyzer 304. In various instances, a system 312 can facilitate such calibration as described herein.

Note that the system 312 can, in some cases, be implemented on or hosted by the mass spectrometer 302 itself or any suitable computerized workstation that is associated with or coupled to the mass spectrometer 302. In such situations, the system 312 can be considered as being deployed in a client-side fashion (e.g., the system 312 can be considered as being local to the mass spectrometer 302). However, in other cases, the system 312 can instead be implemented or hosted remotely from the mass spectrometer 302, such as in a cloud computing environment. In such situations, the system 312 can be considered as being deployed in a server-side fashion.

In various aspects, the system 312 can comprise a processor 314 (e.g., computer processing unit, microprocessor) and a non-transitory computer-readable memory 316 that is operably or operatively or communicatively connected or coupled to the processor 314. The non-transitory computer-readable memory 316 can store computer-executable instructions which, upon execution by the processor 314, can cause the processor 314 or other components of the system 312 (e.g., access component 318, bunching component 320, execution component 322) to perform one or more acts. In various embodiments, the non-transitory computer-readable memory 316 can store computer-executable components (e.g., access component 318, bunching component 320, execution component 322), and the processor 314 can execute the computer-executable components.

In various embodiments, the system 312 can include an access component 318. In various aspects, the access component 318 can electronically access the mass spectrometer 302 and thus the mass analyzer 304. That is, the access component 318 can electronically communicate or otherwise electronically interact with (e.g., transmit electronic instructions or commands to; receive electronic data from) the mass spectrometer 302 in any suitable fashion. Accordingly, the access component 318 can act as a proxy or conduit through which any other components of the system 312 can interact with, communicate with, activate, deactivate, or otherwise manipulate the mass spectrometer 302 or the mass analyzer 304.

In various embodiments, the system 312 can include a bunching component 320. In various aspects, the bunching component 320 can, as described herein, generate a self-bunching heatmap that separates an operational parameter space of the mass analyzer 304 into one or more valid regions and one or more invalid regions.

In various embodiments, the system 312 can include an execution component 322. In various instances, the execution component 322 can, as described herein, perform any suitable electronic actions based on the self-bunching heatmap, such as calibration of the mass analyzer 304 or alert generation for the mass analyzer 304.

Note that, in various instances, the access component 318, the bunching component 320, and the execution component 322 can collectively be considered as being one or more software components 317 of the system 312. In various aspects, it should be appreciated that the one or more software components 317 are described primarily herein as comprising three components (e.g., the access component 318, the bunching component 320, and the execution component 322) for ease of explanation and illustration. However, the one or more software components 317 are not limited to being implemented as exactly such three components in every embodiment. Indeed, in some embodiments, the functionalities described herein of such three components can be combined in any suitable fashions, so as to be implemented in or by fewer than three components (e.g., in some cases, a single component can perform all of the functionalities that are described herein with respect to the access component 318, the bunching component 320, and the execution component 322). In other embodiments, the functionalities described herein of such three components can instead be distributed, separated, split, or fragmented in any suitable fashions, so as to be implemented in or by more than three components (e.g., two or more components can facilitate the functionalities that are performable by the access component 318; two or more components can facilitate the functionalities that are performable by the bunching component 320; two or more components can facilitate the functionalities that are performable by the execution component 322).

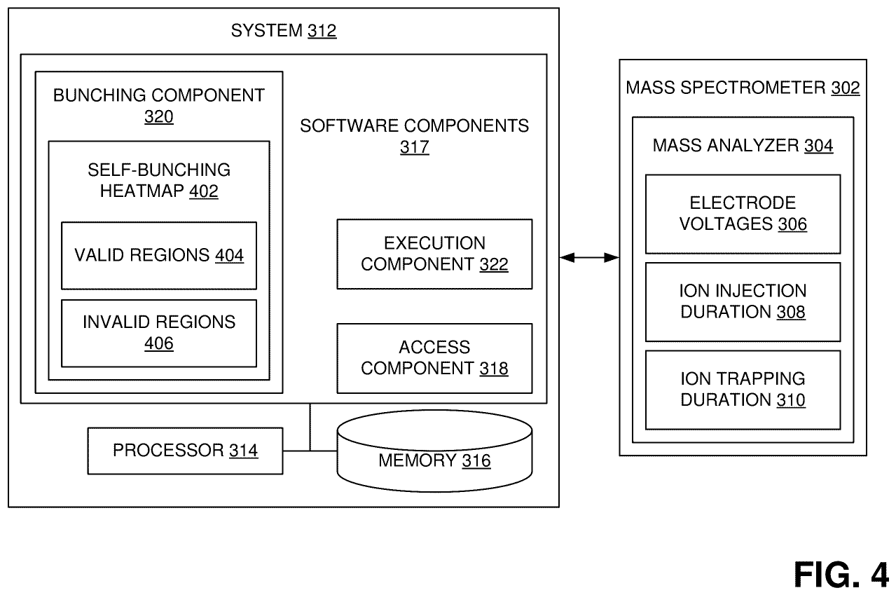

FIG. 4 illustrates a block diagram of an example, non-limiting system including a self-bunching heat map that can facilitate mass analyzer calibration or evaluation via self-bunching computation in accordance with one or more embodiments described herein.

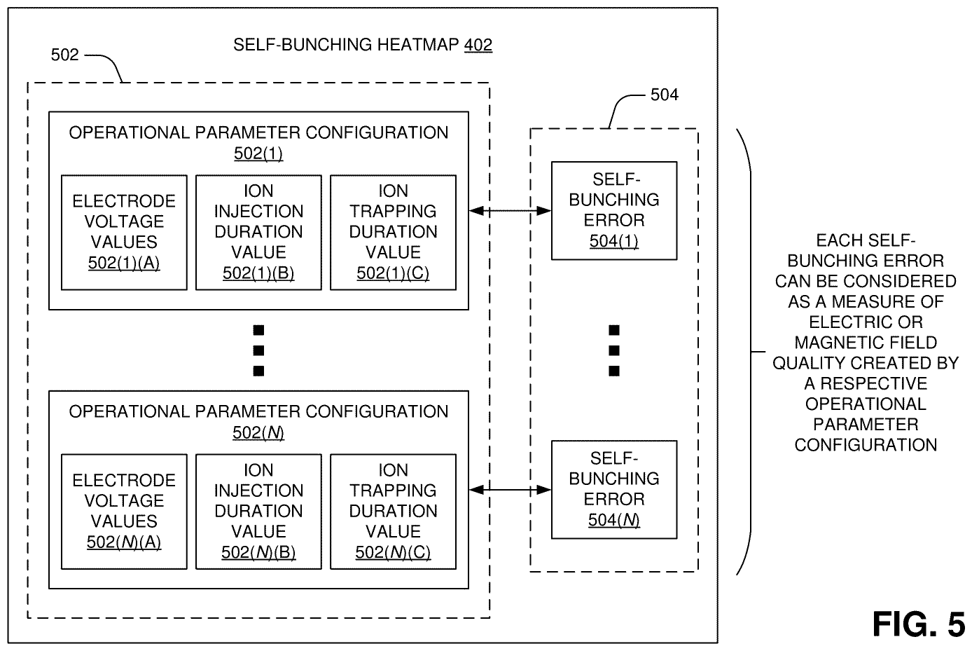

In various embodiments, the bunching component 320 can electronically generate a self-bunching heatmap 402 for the mass analyzer 304. In various aspects, the self-bunching heatmap 402 can be considered as separating, dividing, divvying, or otherwise partitioning an operational parameter space of the mass analyzer 304 into one or more valid regions 404 and one or more invalid regions 406. Various non-limiting details are described with respect to FIGS. 5-9.

FIGS. 5-9 illustrate example, non-limiting block diagrams showing how the self-bunching heatmap 402 can be generated in accordance with one or more embodiments described herein.

First, consider FIG. 5. In various embodiments, the self-bunching heatmap 402 can contain a plurality of operational parameter configurations 502. In various aspects, the plurality of operational parameter configurations 502 can include a total of n configurations, for any suitable positive integer n>1: an operational parameter configuration 502(1) to an operational parameter configuration 502(n). In various instances, each of the plurality of operational parameter configurations 502 can be considered as a unique or distinct location within the operational parameter space of the mass analyzer 304. In other words, each of the plurality of operational parameter configurations 502 can be any suitable electronic data having any suitable format, size, or dimensionality (e.g., can be one or more scalars, one or more vectors, one or more matrices, or one or more tensors) that specifies, indicates, or otherwise represents respective values that could possibly be assigned to or otherwise taken on by the operational parameters of the mass analyzer 304.

As a non-limiting example, the operational parameter configuration 502(1) can specify, indicate, or otherwise represent one or more electrode voltage values 502(1)(A), an ion injection duration value 502(1)(B), or an ion trapping duration value 502(1)(C). In various cases, the one or more electrode voltage values 502(1)(A) can be specific or particular amounts or levels of electric voltage potentials to which the one or more electrode voltages 306 could be controllably set. Likewise, the ion injection duration value 502(1)(B) can be a specific or particular length of time to which the ion injection duration 308 could be controllably set. Similarly, the ion trapping duration value 502(1)(C) can be a specific or particular length of time to which the ion trapping duration 310 could be controllably set.

As another non-limiting example, the operational parameter configuration 502(n) can specify, indicate, or otherwise represent one or more electrode voltage values 502(n)(A), an ion injection duration value 502(n)(B), or an ion trapping duration value 502(n)(C). In various cases, the one or more electrode voltage values 502(n)(A) can be specific or particular amounts or levels of electric voltage potentials to which the one or more electrode voltages 306 could be controllably set. Likewise, the ion injection duration value 502(n)(B) can be a specific or particular length of time to which the ion injection duration 308 could be controllably set. Similarly, the ion trapping duration value 502(n)(C) can be a specific or particular length of time to which the ion trapping duration 310 could be controllably set.

To help clarify, suppose that the mass analyzer 304 has a total of p operational parameters, for any suitable positive integer p>2 (e.g., the ion injection duration 308 plus the ion trapping duration 310 plus p−2 electrode voltages). In such case, the operational parameter space of the mass analyzer 304 can be considered as a p-dimensional Euclidean space. In other words, the operational parameter space can be considered as an abstract space formed by p axes that orthogonally intersect at an origin, with each axis running along or otherwise representing the domain of possible values that can be controllably assigned to a respective one of the p operational parameters of the mass analyzer 304. So, any point or location within that operational parameter space can be indicated or represented as a p-element tuple, each numerical element of which can be a specific scalar value that can be controllably assigned to a respective one of the p operational parameters of the mass analyzer 304. Thus, each of the plurality of operational parameter configurations 502 can be considered as a unique p-element tuple within the operational parameter space. In some aspects, the plurality of operational parameter configurations 502 can be evenly or linearly distributed throughout the operational parameter space, such that the plurality of operational parameter configurations 502 can be considered as regularly spanning the operational parameter space. For example, if q evenly-spaced evaluation points are taken or selected along each of the p axes for any suitable positive integer q, then the operational parameter space can be regularly spanned by a total of n=q^{p} operational parameter configurations. However, in other aspects, the plurality of operational parameter configurations 502 can be unevenly or non-linearly distributed throughout the operational parameter space, such that the plurality of operational parameter configurations 502 can be considered as irregularly spanning the operational parameter space.

In various aspects, the self-bunching heatmap 402 can contain a plurality of self-bunching errors 504. In various instances, the plurality of self-bunching errors 504 can respectively correspond (e.g., in one-to-one fashion) to the plurality of operational parameter configurations 502. So, since the plurality of operational parameter configurations 502 can have a total of n configurations, the plurality of self-bunching errors 504 can likewise have a total of n errors: a self-bunching error 504(1) to a self-bunching error 504(n). In various cases, each of the plurality of self-bunching errors 504 can be a scalar indicating how different the following two ion populations are: an ion population at which ion cloud self-bunching occurs when the mass analyzer 304 is set to or takes on a respective one of the plurality of operational parameter configurations 502; and an ideal or ground-truth ion population at which ion cloud self-bunching is desired to occur. Note that, if any given operational parameter configuration causes ion cloud self-bunching to occur at an ion population that is far from (e.g., much higher than, or much lower than) the ideal or ground-truth ion population, then that given operational parameter configuration can be considered as causing the mass analyzer 304 to create or utilize electric or magnetic fields that are certainly improper or low quality. In contrast, if any given operational parameter configuration causes ion cloud self-bunching to occur at an ion population that is close to (e.g., within any suitable threshold margin of) the ideal or ground-truth ion population, then that given operational parameter configuration can instead be considered as causing the mass analyzer 304 to create or utilize electric or magnetic fields that might be proper or high quality. In this way, each of the plurality of self-bunching errors 504 can be considered as a measure or indicator of the quality or appropriateness of an electric or magnetic field that a respective one of the plurality of operational parameter configurations 502 causes the mass analyzer 304 to create.

As a non-limiting example, the self-bunching error 504(1) can correspond to the operational parameter configuration 502(1). Accordingly, when the mass analyzer 304 implements or utilizes the operational parameter configuration 502(1), ion cloud self-bunching can occur at a first ion population, and the self-bunching error 504(1) can be a scalar whose magnitude indicates how different that first ion population is from the ideal or ground-truth ion population.

As another non-limiting example, the self-bunching error 504(n) can correspond to the operational parameter configuration 502(n). So, when the mass analyzer 304 implements or utilizes the operational parameter configuration 502(n), ion cloud self-bunching can occur at an n-th ion population, and the self-bunching error 504(n) can be a scalar whose magnitude indicates how different that n-th ion population is from the ideal or ground-truth ion population.

In various aspects, there can be any suitable threshold error value. If any given operational parameter configuration has a self-bunching error that is above that threshold error value, that given operational parameter configuration can be considered as causing the mass analyzer 304 to create electric or magnetic fields that are clearly improper or low quality. Thus, that given operational parameter configuration can be treated or labeled as “invalid.” On the other hand, if any given operational parameter configuration has a self-bunching error that is below that threshold error value, that given operational parameter configuration can be considered as causing the mass analyzer 304 to create electric or magnetic fields that might potentially be proper or high quality. So, that given operational parameter configuration can instead be treated or labeled as “valid.” In various instances, valid operational parameter configurations can tend to cluster together or otherwise be near each other within the operational parameter space. Likewise, invalid operational parameter configurations can tend to cluster together or otherwise be near each other within the operational parameter space. Accordingly, each cluster of valid operational parameter configurations (e.g., which can be identified via any suitable clustering or community detection algorithm) can be considered as forming, belonging to, or otherwise demarcating the one or more valid regions 404. Conversely, each cluster of invalid operational parameter configurations (e.g., which can be identified via any suitable clustering or community detection algorithm) can be considered as forming, belonging to, or otherwise demarcating the one or more invalid regions 406. In this way, the self-bunching heatmap 402 can be considered as separating or dividing the operational parameter space of the mass analyzer 304 into the one or more valid regions 404 and the one or more invalid regions 406.

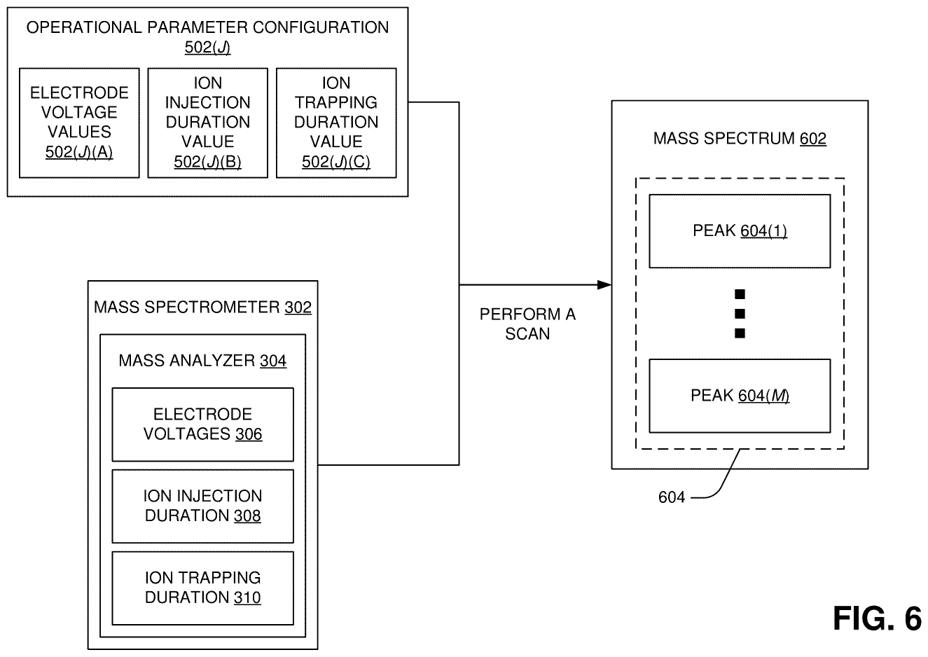

FIGS. 6-9 show how the bunching component 320 can generate or compute the plurality of self-bunching errors 504 when given the plurality of operational parameter configurations 502.

Consider FIG. 6. In various embodiments, the bunching component 320 can select any one of the plurality of operational parameter configurations 502. In various aspects, such selected configuration can be referred to as an operational parameter configuration 502(j), for any suitable positive integer j≤n. Just as described above, the operational parameter configuration 502(j) can contain or include one or more electrode voltage values 502(j)(A), an ion injection duration value 502(j)(B), or an ion trapping duration value 502(j)(C). In various instances, the bunching component 320 can electronically instruct or electronically command the mass spectrometer 302 to perform a scan (e.g., on any suitable sample or specimen, or possibly on no sample or specimen at all) using the operational parameter configuration 502(j). That is, the bunching component 320 can electronically cause the mass spectrometer 302 to perform a scan with the operational parameters of the mass analyzer 304 being set to whatever specific values are specified or indicated by the operational parameter configuration 502(j). In any case, such scan (which can consume mere milliseconds to perform) can yield a mass spectrum 602.

In various aspects, the mass spectrum 602 can be a graph or chart of relative ion abundance as a function of mass-to-charge ratio. In other words, an abscissa axis of the mass spectrum 602 can represent mass-to-charge ratio, whereas an ordinate axis of the mass spectrum 602 can represent relative ion abundance. In various instances, the mass spectrum 602 can exhibit, have, or otherwise contain a plurality of peaks 604. In various cases, the plurality of peaks 604 can include a total of m peaks for any suitable positive integer m>1: a peak 604(1) to a peak 604(m). In various aspects, each of the plurality of peaks 604 can be considered as a locally-maximum relative ion abundance value that is located at a respective mass-to-charge ratio.

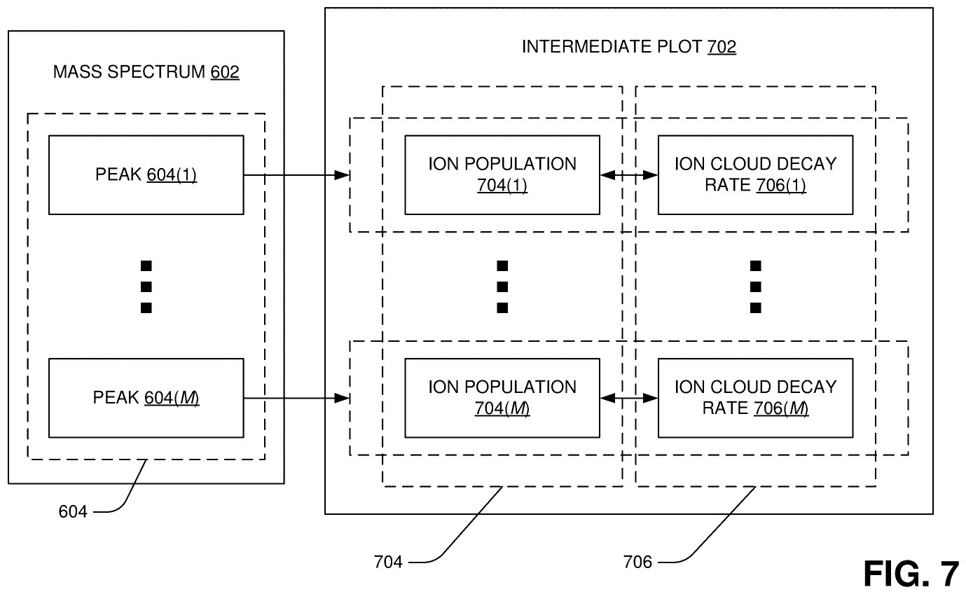

Next, consider FIG. 7. In various embodiments, the bunching component 320 can electronically generate an intermediate plot 702, based on the mass spectrum 602. In particular, each of the plurality of peaks 604 can be considered as having or otherwise exhibiting various characteristics, attributes, or properties. In various aspects, such characteristics, attributes, or properties can include ion population (e.g., the number of ions that made up a given peak) and ion cloud decay rate (e.g., the speed at which the ions making up a given peak were being removed from that given peak by decoherence or collisional effects).

As a non-limiting example, the peak 604(1) can be considered as having or otherwise exhibiting an ion population 704(1) and an ion cloud decay rate 706(1). The ion population 704(1) can be a scalar indicating how many ions made up or belonged to the peak 604(1), and the ion cloud decay rate 706(1) can be a scalar indicating how quickly those ions were being removed or displaced from the peak 604(1).

As another non-limiting example, the peak 604(m) can be considered as having or otherwise exhibiting an ion population 704(m) and an ion cloud decay rate 706(m). The ion population 704(m) can be a scalar indicating how many ions made up or belonged to the peak 604(m), and the ion cloud decay rate 706(m) can be a scalar indicating how quickly those ions were being removed or displaced from the peak 604(m).

In various aspects, the ion population 704(1) to the ion population 704(m) can be considered as collectively forming a plurality of ion populations 704. Likewise, the ion cloud decay rate 706(1) to the ion cloud decay rate 706(m) can be considered as collectively forming a plurality of ion cloud decay rates 706 that respectively correspond (e.g., in one-to-one fashion) with the plurality of ion populations 704. So, the plurality of ion populations 704 and the plurality of ion cloud decay rates 706 can together be considered as forming a total of m population-and-decay-rate tuples (e.g., the ion population 704(1) and the ion cloud decay rate 706(1) can be considered as a first population-and-decay-rate tuple; the ion population 704(m) and the ion cloud decay rate 706(m) can be considered as an m-th population-and-decay-rate tuple), and such m tuples can be considered as forming or being the intermediate plot 702. In other words, the intermediate plot 702 can be considered as a graph or chart that shows ion cloud decay rate as a function of ion population. In still other words, an abscissa axis of the intermediate plot 702 can be or represent ion population, and an ordinate axis of the intermediate plot 702 can be or represent ion cloud decay rate.

Note that, in various aspects, the intermediate plot 702 can implement, contain, or otherwise be defined by any suitable proxy for ion population rather than ion population itself, for ease of implementation. As a non-limiting example, signal-to-noise ratio can be easily calculated for each of the plurality of peaks 604 (e.g., signal-to-noise ratio can be equal to height of a given peak divided by standard deviation of background noise around that given peak) and can be considered as varying proportionally with ion population.

Similarly, in various instances, the intermediate plot 702 can implement, contain, or otherwise be defined by any suitable proxy for ion cloud decay rate rather than ion cloud decay rate itself, for ease of implementation. As a non-limiting example, normalized resolution can be easily calculated for each of the plurality of peaks 604 (e.g., measured resolution of a given peak can be equal to mass-to-charge ratio at which the given peak occurs (denoted as m/zₚₑₐₖ) divided by the full-width-at-half-maximum of that given peak; theoretical resolution of the given peak can be equal to

$$\sqrt{\frac{k}{m / {z}_{p e a k}}}$$

multiplied by whatever resolution setting the mass spectrometer 302 utilized to generate the mass spectrum 602, where k can represent whatever reference m/z value whose measured resolution is known, deemed, or expected to be equal to that resolution setting (e.g., for a resolution setting of 15000, k can be equal to 200, since a peak at an m/z value of 200 can be expected to have a measured resolution of 15000); and normalized resolution of the given peak can be equal to the measured resolution of the given peak divided by the theoretical resolution of the given peak) and can be considered as varying proportionally with ion cloud decay rate.

So, in some cases, the intermediate plot 702 can be considered as showing ion cloud decay rate as a function of ion population. However, in other cases, the intermediate plot 702 can be considered as showing normalized resolution (which is a proxy for ion cloud decay rate) as a function of signal-to-noise ratio (which is a proxy for ion population).

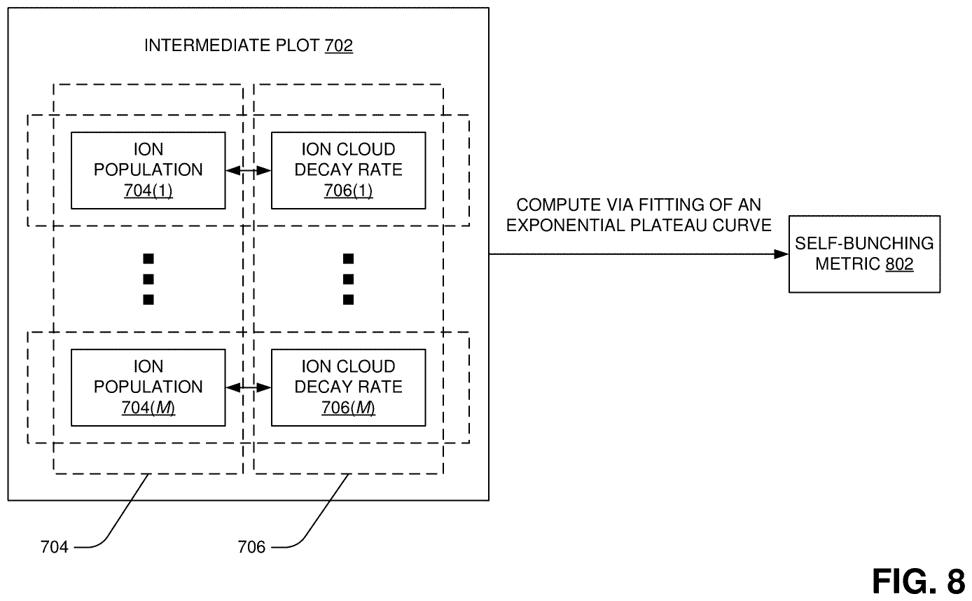

Now, consider FIG. 8. In various embodiments, the bunching component 320 can electronically compute or otherwise electronically identify a self-bunching metric 802 for the operational parameter configuration 502(j), by fitting an exponential plateau curve to the intermediate plot 702. As a non-limiting example, the exponential plateau curve can be given by y(x)=C₁(1−e^{-C}^{₂}^{x})+C₃, where x can represent ion population (or any proxy thereof), where y(x) can represent ion cloud decay rate (or any proxy thereof), and wherein C₁, C₂, and C₃ can represent fitting coefficients. In such case, the bunching component 320 can compute, via any suitable fitting technique (e.g., least sum of squares) what specific values of C₁, C₂, and C₃ minimize a difference or error (e.g., L₂ norm) between the intermediate plot 702 and the exponential plateau curve. In various instances, the self-bunching metric 802 can be a scalar that represents the specific ion population (or proxy thereof) at which ion cloud self-bunching occurs when the mass analyzer 304 utilizes the operational parameter configuration 502(j), and the bunching component 320 can electronically compute or identify the self-bunching metric 802 based on the fitted exponential plateau curve. For instance, the fitted exponential plateau curve can be considered as having a supremum, upper bound, or horizontal asymptote at an ion cloud decay rate (or proxy thereof) that is equal to C₁+C₃, and the self-bunching metric 802 can be equal to whatever ion population (or proxy thereof) causes the fitted exponential plateau curve to be within any threshold percentage (e.g., 95%) of that supremum, upper bound, or horizontal asymptote. As another instance, the self-bunching metric 802 can be equal to whatever ion population (or proxy thereof) at which the fitted exponential plateau curve exhibits a threshold derivative or slope.

In any case, the self-bunching metric 802 can be considered at the ion population (or proxy thereof) at which ion cloud self-bunching occurs or manifests, when the mass analyzer 304 performs a scan according to the operational parameter configuration 502(j).

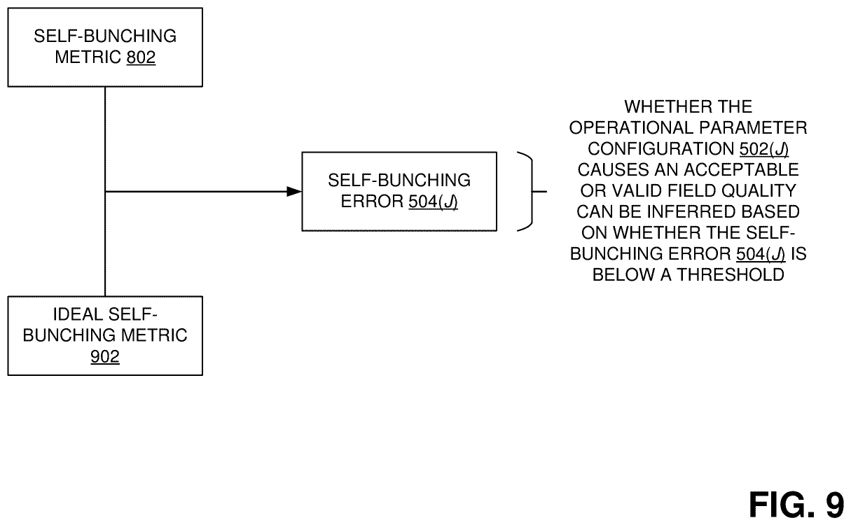

Next, consider FIG. 9. In various embodiments, there can be an ideal self-bunching metric 902. In various aspects, the ideal self-bunching metric 902 can be a scalar indicating a ground-truth ion population (or proxy thereof) at which self-bunching is desired to occur. In some instances, the ideal self-bunching metric 902 can be identified empirically by: causing a mass analyzer that is known or deemed to be properly fabricated and properly calibrated to perform a scan, thereby yielding a resultant mass spectrum; generating (as described with respect to FIG. 7) an intermediate plot from that resultant mass spectrum; and fitting (as described with respect to FIG. 8) the exponential plateau curve to that intermediate plot. In any case, the bunching component 320 can compute or calculate any suitable error or loss value between the self-bunching metric 802 and the ideal self-bunching metric 902, and such error or loss value can be referred to as a self-bunching error 504(j), which can be considered as being one of the plurality of self-bunching errors 504. As a non-limiting example, the self-bunching error 504(j) can be equal to an absolute value difference between the self-bunching metric 802 and the ideal self-bunching metric 902. As another non-limiting example, the self-bunching error 504(j) can be equal to a squared difference between the self-bunching metric 802 and the ideal self-bunching metric 902. In any case, the quality or propriety of the electric or magnetic fields generated by the mass analyzer 304 when the mass analyzer 304 is set to the operational parameter configuration 502(j) can be at least partially inferred or judged based on the self-bunching error 504(j). For instance, if the self-bunching error 504(j) is above any suitable threshold value (e.g., if the self-bunching metric 802 is too far away from the ideal self-bunching metric 902), then it can be inferred or concluded that the operational parameter configuration 502(j) causes the mass analyzer 304 to create electric or magnetic fields that are definitely or certainly improper or low quality. In such case, the operational parameter configuration 502(j) can be labeled as “invalid.” In contrast, if the self-bunching error 504(j) is below any suitable threshold value (e.g., if the self-bunching metric 802 is close to the ideal self-bunching metric 902), then it can be inferred or concluded that the operational parameter configuration 502(j) causes the mass analyzer 304 to create electric or magnetic fields that might possibly be proper or high quality. In such case, the operational parameter configuration 502(j) can be labeled as “valid.”

By performing the actions described with respect to FIGS. 6-9 for each of the plurality of operational parameter configurations 502, the bunching component 320 can electronically compute the plurality of self-bunching errors 504. In this way, the self-bunching heatmap 402 can be obtained.

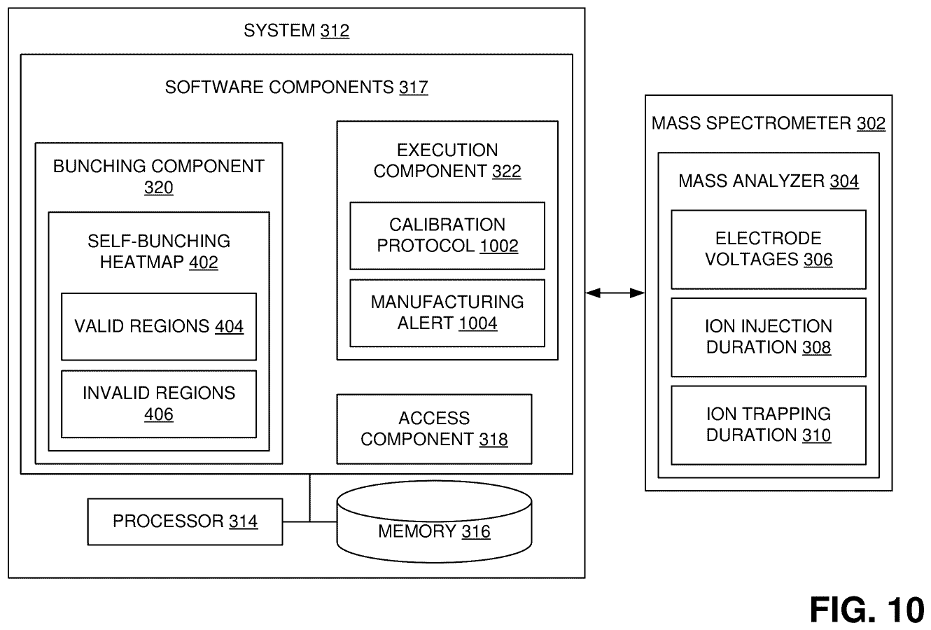

FIG. 10 illustrates a block diagram of an example, non-limiting system including a calibration protocol or a manufacturing alert that can facilitate mass analyzer evaluation via self-bunching computation in accordance with one or more embodiments described herein.

In various embodiments, the execution component 322 can perform, conduct, or otherwise initiate any suitable electronic actions based on the self-bunching heatmap 402.

As a non-limiting example, the execution component 322 can electronically perform on the mass analyzer 304 a calibration protocol 1002 within the one or more valid regions 404 but not within the one or more invalid regions 406. In particular, the calibration protocol 1002 can be any suitable procedure or technique for calibrating the operational parameters of the mass analyzer 304, such as a single-point or multi-point calibration procedure that utilizes any suitable reference mixtures, compounds, isotopes, or standards. No matter the specific procedure or technique that is embodied by the calibration protocol 1002, the calibration protocol 1002 can be considered as a search through the operational parameter space of the mass analyzer 304 for specific operational parameter values that optimize or otherwise achieve a desired performance of the mass analyzer 304. Because of the high-dimensionality of the operational parameter space, the calibration protocol 1002 can be associated with a high level of time consumption or computing resource consumption (e.g., can require dozens of minutes to hours to perform). In various cases, such time consumption or computing resource consumption can be reduced, by limiting the search only to the one or more valid regions 404 within the operating parameter space. In other words, because the configurations that make up the one or more invalid regions 406 caused the mass analyzer 304 to exhibit ion cloud self-bunching at wrong or incorrect ion populations, it can be confidently concluded that those configurations certainly cannot be the finalized calibration configuration that is ultimately found by the calibration protocol 1002. Thus, the execution component 322 can ignore the one or more invalid regions 406 when performing the calibration protocol 1002, such that no time or computing resources are wasted by the calibration protocol 1002 on searching through the one or more invalid regions 406. Stated differently, because the one or more invalid regions 406 cause the mass analyzer 304 to exhibit poor or incorrect self-bunching, the one or more invalid regions 406 can be considered as not being worth any attention by the calibration protocol 1002. In this way, a time consumption or computing resource consumption of the calibration protocol 1002 can be reduced (e.g., since the total search space that the calibration protocol 1002 needs to traverse can be effectively shrunk by the self-bunching heatmap 402). That is, the mass analyzer 304 can be calibrated in less time or with less processing power than would otherwise be possible.

As another non-limiting example, the execution component 322 can utilize or leverage the self-bunching heatmap 402 to evaluate the mass analyzer 304 for any suitable non-calibration purposes. For instance, suppose that the mass analyzer 304 is a fabricated instantiation of a central or principal mass analyzer design or schematic. Further suppose that the mass analyzer 304 was fabricated via a first type of manufacturing process or from raw materials provided by a first supplier, whereas the central or principal design or schematic was originally intended to be fabricated using a different type of manufacturing process or from raw materials provided by a different supplier. In such case, the execution component 322 can electronically determine whether or not that first manufacturing process or that first supplier are appropriate, reliable, or satisfactory, by comparing: the self-bunching heatmap 402; to an ideal or ground-truth self-bunching heatmap that was generated for a mass analyzer that was properly fabricated according to the central or principal design or schematic using the different manufacturing process or the different supplier. In various aspects, the execution component 322 can facilitate such comparison via the computation of any suitable type of error (e.g., mean absolute error, mean squared error, cross-entropy error) between the self-bunching heatmap 402 and the ground-truth or ideal self-bunching heatmap. If that error is above any suitable threshold (e.g., if the one or more valid regions 404 do not match whatever valid regions are indicated in the ground-truth or ideal self-bunching heatmap, or if the one or more invalid regions 406 do not match whatever invalid regions are indicated in the ground-truth or ideal self-bunching heatmap), then the execution component 322 can electronically generate a manufacturing alert 1004. In various cases, the manufacturing alert 1004 can be any suitable electronic message that textually, visually, or audibly conveys that the mass analyzer 304 was not fabricated correctly. In various instances, the execution component 322 can electronically transmit the manufacturing alert 1004 to any suitable computing device or can electronically render the manufacturing alert 1004 on any suitable electronical display or electronic speaker associated with the mass spectrometer 302.

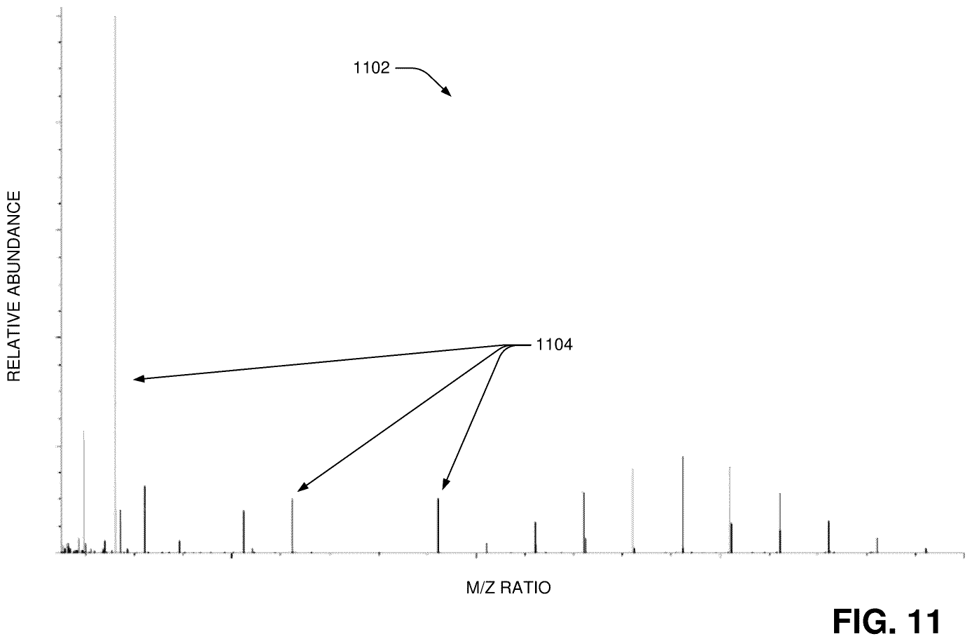

FIGS. 11-14 illustrate example, non-limiting experimental results in accordance with one or more embodiments described herein. In particular, FIGS. 11-14 show a real-world example of how a self-bunching heatmap can be obtained for a real-world mass analyzer.

FIG. 11 depicts a mass spectrum 1102 having a plurality of peaks 1104. The mass spectrum 1102 is a real-world spectrum produced by a real-world mass analyzer using a particular operational parameter configuration (e.g., using particular electrode voltage values, using particular injection or trapping times).

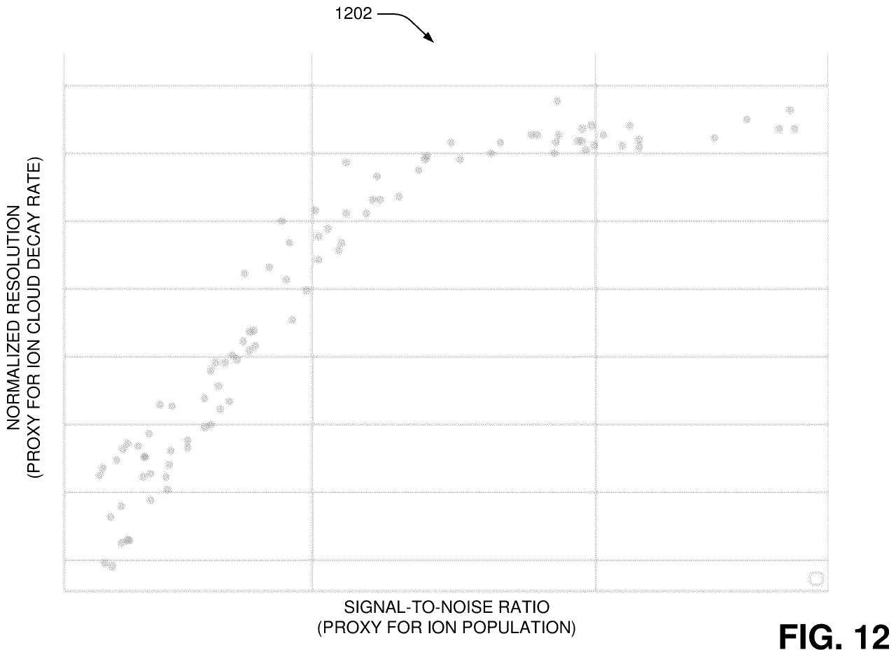

FIG. 12 depicts an intermediate plot 1202. As shown, the abscissa axis of the intermediate plot 1202 represents signal-to-noise ratio (which is a proxy for ion population), and the ordinate axis of the intermediate plot 1202 represents normalized resolution (which is a proxy of ion cloud decay rate). The intermediate plot 1202 was obtained by computing a respective signal-to-noise ratio and a respective normalized resolution for each peak in the mass spectrum 1102.

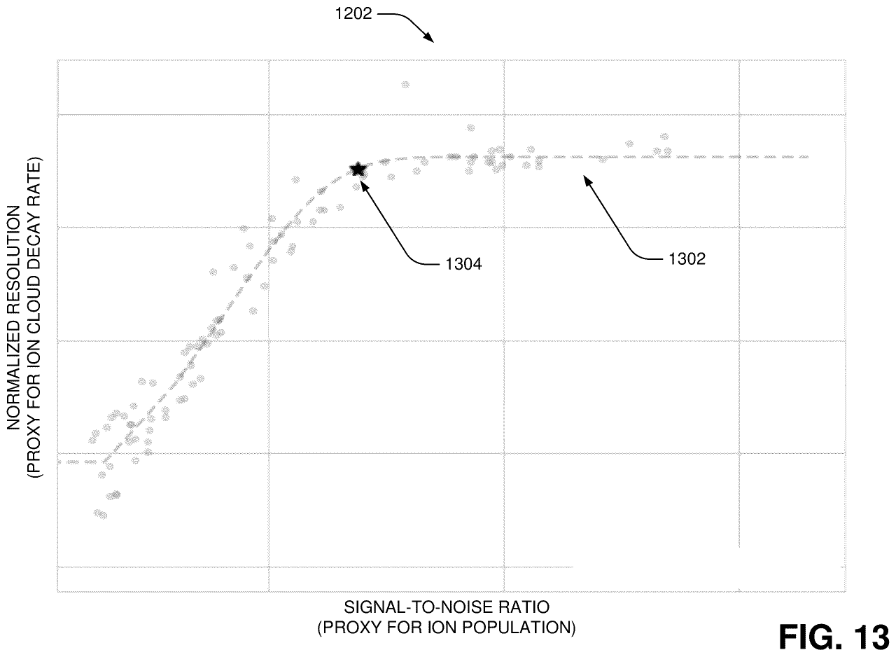

FIG. 13 depicts the intermediate plot 1202 with a fitted exponential plateau curve 1302 and with a self-bunching initiation point 1304. In this non-limiting example, the self-bunching initiation point is located on the fitted exponential plateau curve at a normalized resolution that is equal to 95% of the upper asymptote of the fitted exponential plateau curve 1302. In various cases, the specific signal-to-noise ratio that corresponds to the self-bunching initiation point 1304 can be considered as the self-bunching metric for whatever operational parameter configuration was used to generate the mass spectrum 1102.

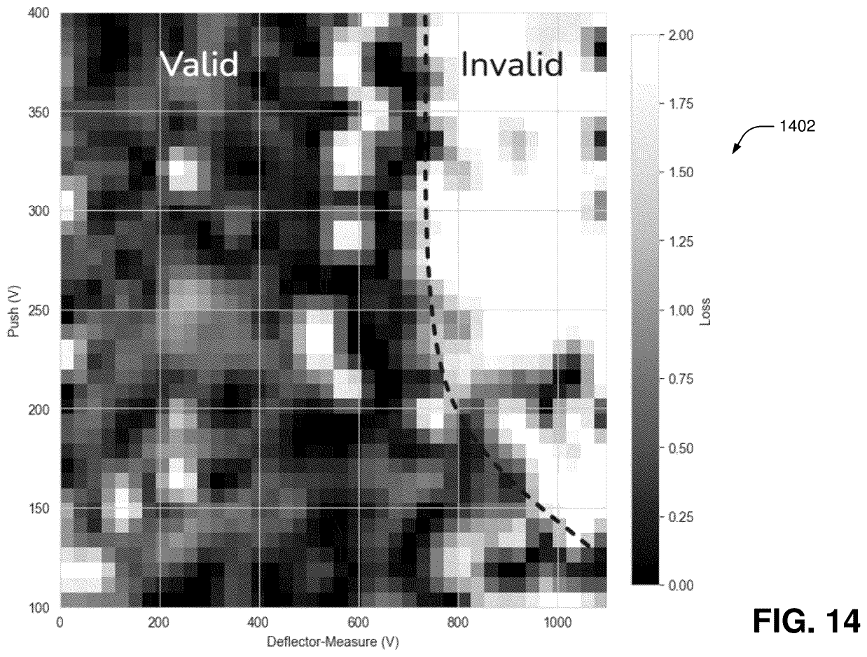

FIG. 14 depicts a self-bunching heatmap 1402. In practice, a self-bunching heatmap can be difficult to visualize, due to mass analyzers having numerous (e.g., a dozen or more) operational parameters. For ease of illustration, in the non-limiting example of FIG. 14, the self-bunching heatmap 1402 was generated only for two operational parameters: push-electrode voltage and deflector-electrode voltage. As shown, each individual location within the self-bunching heatmap 1402 is a push-deflector tuple that has a respective self-bunching error or loss value. In FIG. 14, darker colors represent lower self-bunching error or loss values, whereas lighter colors represent higher self-bunching error or loss values. So, the predominantly dark region within the self-bunching heatmap 1402 can be considered as a valid calibration search space. In contrast, the predominantly light region within the self-bunching heatmap 1402 can be considered as an invalid calibration search space. Thus, when it is desired to calibrate whatever mass analyzer for which the self-bunching heatmap 1402 was generated, such calibration can ignore, and thus not waste any time paying attention to or searching through, push-deflector tuples that are located in the invalid region. In this way, the time or resource costs of calibration can be reduced.

In various instances, machine learning algorithms or models can be implemented in any suitable way to facilitate any suitable aspects described herein. To facilitate some of the above-described machine learning aspects of various embodiments, consider the following discussion of artificial intelligence (AI). Various embodiments described herein can employ artificial intelligence to facilitate automating one or more features or functionalities. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system or environment from a set of observations as captured via events or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events or data.

Such determinations can result in the construction of new events or actions from a set of observed events or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes or systems (e.g., support vector machines, neural networks, expert systems, Bayesian belief networks, fuzzy logic, data fusion engines, and so on) in connection with performing automatic or determined action in connection with the claimed subject matter. Thus, classification schemes or systems can be used to automatically learn and perform a number of functions, actions, or determinations.

A classifier can map an input attribute vector, z=(z₁, z₂, z₃, z₄, zₙ), to a confidence that the input belongs to a class, as by f(z)=confidence(class). Such classification can employ a probabilistic or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, or probabilistic classification models providing different patterns of independence, any of which can be employed. Classification as used herein also is inclusive of statistical regression that is utilized to develop models of priority.

In order to provide additional context for various embodiments described herein, FIG. 15 and the following discussion are intended to provide a brief, general description of a suitable computing environment 1500 in which the various embodiments of the embodiment described herein can be implemented. While the embodiments have been described above in the general context of computer-executable instructions that can run on one or more computers, those skilled in the art will recognize that the embodiments can be also implemented in combination with other program modules or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multi-processor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 15, the example environment 1500 for implementing various embodiments of the aspects described herein includes a computer 1502, the computer 1502 including a processing unit 1504, a system memory 1506 and a system bus 1508. The system bus 1508 couples system components including, but not limited to, the system memory 1506 to the processing unit 1504. The processing unit 1504 can be any of various commercially available processors. Dual microprocessors and other multi-processor architectures can also be employed as the processing unit 1504.

The system bus 1508 can be any of several types of bus structure that can further interconnect to a memory bus (with or without a memory controller), a peripheral bus, and a local bus using any of a variety of commercially available bus architectures. The system memory 1506 includes ROM 1510 and RAM 1512. A basic input/output system (BIOS) can be stored in a non-volatile memory such as ROM, erasable programmable read only memory (EPROM), EEPROM, which BIOS contains the basic routines that help to transfer information between elements within the computer 1502, such as during startup. The RAM 1512 can also include a high-speed RAM such as static RAM for caching data.

The computer 1502 further includes an internal hard disk drive (HDD) 1514 (e.g., EIDE, SATA), one or more external storage devices 1516 (e.g., a magnetic floppy disk drive (FDD) 1516, a memory stick or flash drive reader, a memory card reader, etc.) and a drive 1520, e.g., such as a solid state drive, an optical disk drive, which can read or write from a disk 1522, such as a CD-ROM disc, a DVD, a BD, etc. Alternatively, where a solid state drive is involved, disk 1522 would not be included, unless separate. While the internal HDD 1514 is illustrated as located within the computer 1502, the internal HDD 1514 can also be configured for external use in a suitable chassis (not shown). Additionally, while not shown in environment 1500, a solid state drive (SSD) could be used in addition to, or in place of, an HDD 1514. The HDD 1514, external storage device(s) 1516 and drive 1520 can be connected to the system bus 1508 by an HDD interface 1524, an external storage interface 1526 and a drive interface 1528, respectively. The interface 1524 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1502, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1512, including an operating system 1530, one or more application programs 1532, other program modules 1534 and program data 1536. All or portions of the operating system, applications, modules, or data can also be cached in the RAM 1512. The systems and methods described herein can be implemented utilizing various commercially available operating systems or combinations of operating systems.

Computer 1502 can optionally comprise emulation technologies. For example, a hypervisor (not shown) or other intermediary can emulate a hardware environment for operating system 1530, and the emulated hardware can optionally be different from the hardware illustrated in FIG. 15. In such an embodiment, operating system 1530 can comprise one virtual machine (VM) of multiple VMs hosted at computer 1502. Furthermore, operating system 1530 can provide runtime environments, such as the Java runtime environment or the .NET framework, for applications 1532. Runtime environments are consistent execution environments that allow applications 1532 to run on any operating system that includes the runtime environment. Similarly, operating system 1530 can support containers, and applications 1532 can be in the form of containers, which are lightweight, standalone, executable packages of software that include, e.g., code, runtime, system tools, system libraries and settings for an application.

Further, computer 1502 can be enable with a security module, such as a trusted processing module (TPM). For instance with a TPM, boot components hash next in time boot components, and wait for a match of results to secured values, before loading a next boot component. This process can take place at any layer in the code execution stack of computer 1502, e.g., applied at the application execution level or at the operating system (OS) kernel level, thereby enabling security at any level of code execution.

A user can enter commands and information into the computer 1502 through one or more wired/wireless input devices, e.g., a keyboard 1538, a touch screen 1540, and a pointing device, such as a mouse 1542. Other input devices (not shown) can include a microphone, an infrared (IR) remote control, a radio frequency (RF) remote control, or other remote control, a joystick, a virtual reality controller or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1504 through an input device interface 1544 that can be coupled to the system bus 1508, but can be connected by other interfaces, such as a parallel port, an IEEE 1394 serial port, a game port, a USB port, an IR interface, a BLUETOOTH® interface, etc.

A monitor 1546 or other type of display device can be also connected to the system bus 1508 via an interface, such as a video adapter 1548. In addition to the monitor 1546, a computer typically includes other peripheral output devices (not shown), such as speakers, printers, etc.

The computer 1502 can operate in a networked environment using logical connections via wired or wireless communications to one or more remote computers, such as a remote computer(s) 1550. The remote computer(s) 1550 can be a workstation, a server computer, a router, a personal computer, portable computer, microprocessor-based entertainment appliance, a peer device or other common network node, and typically includes many or all of the elements described relative to the computer 1502, although, for purposes of brevity, only a memory/storage device 1552 is illustrated. The logical connections depicted include wired/wireless connectivity to a local area network (LAN) 1554 or larger networks, e.g., a wide area network (WAN) 1556. Such LAN and WAN networking environments are commonplace in offices and companies, and facilitate enterprise-wide computer networks, such as intranets, all of which can connect to a global communications network, e.g., the Internet.

When used in a LAN networking environment, the computer 1502 can be connected to the local network 1554 through a wired or wireless communication network interface or adapter 1558. The adapter 1558 can facilitate wired or wireless communication to the LAN 1554, which can also include a wireless access point (AP) disposed thereon for communicating with the adapter 1558 in a wireless mode.

When used in a WAN networking environment, the computer 1502 can include a modem 1560 or can be connected to a communications server on the WAN 1556 via other means for establishing communications over the WAN 1556, such as by way of the Internet. The modem 1560, which can be internal or external and a wired or wireless device, can be connected to the system bus 1508 via the input device interface 1544. In a networked environment, program modules depicted relative to the computer 1502 or portions thereof, can be stored in the remote memory/storage device 1552. It will be appreciated that the network connections shown are example and other means of establishing a communications link between the computers can be used.

When used in either a LAN or WAN networking environment, the computer 1502 can access cloud storage systems or other network-based storage systems in addition to, or in place of, external storage devices 1516 as described above, such as but not limited to a network virtual machine providing one or more aspects of storage or processing of information. Generally, a connection between the computer 1502 and a cloud storage system can be established over a LAN 1554 or WAN 1556 e.g., by the adapter 1558 or modem 1560, respectively. Upon connecting the computer 1502 to an associated cloud storage system, the external storage interface 1526 can, with the aid of the adapter 1558 or modem 1560, manage storage provided by the cloud storage system as it would other types of external storage. For instance, the external storage interface 1526 can be configured to provide access to cloud storage sources as if those sources were physically connected to the computer 1502.

The computer 1502 can be operable to communicate with any wireless devices or entities operatively disposed in wireless communication, e.g., a printer, scanner, desktop or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

FIG. 16 is a schematic block diagram of a sample computing environment 1600 with which the disclosed subject matter can interact. The sample computing environment 1600 includes one or more client(s) 1610. The client(s) 1610 can be hardware or software (e.g., threads, processes, computing devices). The sample computing environment 1600 also includes one or more server(s) 1630. The server(s) 1630 can also be hardware or software (e.g., threads, processes, computing devices). The servers 1630 can house threads to perform transformations by employing one or more embodiments as described herein, for example. One possible communication between a client 1610 and a server 1630 can be in the form of a data packet adapted to be transmitted between two or more computer processes. The sample computing environment 1600 includes a communication framework 1650 that can be employed to facilitate communications between the client(s) 1610 and the server(s) 1630. The client(s) 1610 are operably connected to one or more client data store(s) 1620 that can be employed to store information local to the client(s) 1610. Similarly, the server(s) 1630 are operably connected to one or more server data store(s) 1640 that can be employed to store information local to the servers 1630.

Various embodiments may be a system, a method, an apparatus or a computer program product at any possible technical detail level of integration. The computer program product can include a computer readable storage medium (or media) having computer readable program instructions thereon for causing a processor to carry out aspects of various embodiments. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of various embodiments can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform various aspects.

Various aspects are described herein with reference to flowchart illustrations or block diagrams of methods, apparatus (systems), and computer program products according to various embodiments. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus, or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart or block diagram block or blocks.

The flowcharts and block diagrams in the Figures illustrate the architecture, functionality, and operation of possible implementations of systems, methods, and computer program products according to various embodiments. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that this disclosure also can or can be implemented in combination with other program modules. Generally, program modules include routines, programs, components, data structures, etc. that perform particular tasks or implement particular abstract data types. Moreover, those skilled in the art will appreciate that various aspects can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system, or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

The herein disclosure describes non-limiting examples. For ease of description or explanation, various portions of the herein disclosure utilize the term “each,” “every,” or “all” when discussing various examples. Such usages of the term “each,” “every,” or “all” are non-limiting. In other words, when the herein disclosure provides a description that is applied to “each,” “every,” or “all” of some particular object or component, it should be understood that this is a non-limiting example, and it should be further understood that, in various other examples, it can be the case that such description applies to fewer than “each,” “every,” or “all” of that particular object or component.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM)(e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various non-limiting aspects are described in the following examples.

EXAMPLE 1: A system can comprise: a processor that executes computer-executable components stored in a non-transitory computer-readable memory, wherein the computer-executable components can comprise: an access component that can access a mass analyzer; and a bunching component that can separate an operational parameter space of the mass analyzer into a valid region and an invalid region, based on computing ion cloud self-bunching metrics at respective locations in the operational parameter space.

EXAMPLE 2: The system of any preceding example can be implemented, wherein the computer-executable components can comprise: an execution component that can perform a calibration protocol on the mass analyzer within the valid region and not within the invalid region.

EXAMPLE 3: The system of any preceding example can be implemented, wherein the computer-executable components can comprise: an execution component that can generate an alert in response to the valid region not matching a ground-truth valid region or in response to the invalid region not matching a ground-truth invalid region, wherein the alert can indicate that a manufacturing or supply change associated with the mass analyzer was not successful.

EXAMPLE 4: The system of any preceding example can be implemented, wherein, for a first location within the operational parameter space, the bunching component can cause the mass analyzer to perform a scan, thereby yielding a first mass spectrum that shows relative ion abundance as a function of mass-to-charge ratio.

EXAMPLE 5: The system of any preceding example can be implemented, wherein, for each peak in the first mass spectrum, the bunching component can compute a respective ion cloud decay rate or proxy thereof and a respective ion population or proxy thereof, thereby yielding a first intermediate plot.

EXAMPLE 6: The system of any preceding example can be implemented, wherein the bunching component can identify a first ion cloud self-bunching metric for the first location in the operational parameter space, based on fitting an exponential plateau function to the first intermediate plot.

EXAMPLE 7: The system of any preceding example can be implemented, wherein the bunching component can: compute a first loss between the first ion cloud self-bunching metric and an ideal ion cloud self-bunching metric; label the first location in the operational parameter space as valid, in response to the first loss falling below a threshold value; and label the first location in the operational parameter space as invalid, in response to the first loss exceeding the threshold value.

EXAMPLE 8: The system of any preceding example can be implemented, wherein the mass analyzer can belong to a Fourier transform mass spectrometer.

EXAMPLE 9: The system of any preceding example can be implemented, wherein the operational parameter space can comprise: one or more electrode voltage parameters of the mass analyzer; or one or more timing parameters of the mass analyzer.

In various embodiments, any combination or combinations of examples 1-9 can be implemented.

EXAMPLE 10: A computer-implemented method can comprise: accessing, by a device operatively coupled to a processor, a mass analyzer; and separating, by the device, an operational parameter space of the mass analyzer into a valid region and an invalid region, based on computing ion cloud self-bunching metrics at respective locations in the operational parameter space.

EXAMPLE 11: The computer-implemented method of any preceding example can be implemented, further comprising: performing, by the device, a calibration protocol on the mass analyzer within the valid region and not within the invalid region.

EXAMPLE 12: The computer-implemented method of any preceding example can be implemented, further comprising: generating, by the device, an alert in response to the valid region not matching a ground-truth valid region or in response to the invalid region not matching a ground-truth invalid region, wherein the alert indicates that a manufacturing or supply change associated with the mass analyzer was not successful.

EXAMPLE 13: The computer-implemented method of any preceding example can be implemented, wherein the separating can comprise: causing, by the device and for a first location within the operational parameter space, the mass analyzer to perform a scan, thereby yielding a first mass spectrum that shows relative ion abundance as a function of mass-to-charge ratio.

EXAMPLE 14: The computer-implemented method of any preceding example can be implemented, wherein the separating can comprise: computing, by the device and for each peak in the first mass spectrum, a respective ion cloud decay rate or proxy thereof and a respective ion population or proxy thereof, thereby yielding a first intermediate plot.

EXAMPLE 15: The computer-implemented method of any preceding example can be implemented, wherein the separating can comprise: identifying, by the device, a first ion cloud self-bunching metric for the first location in the operational parameter space, based on fitting an exponential plateau function to the first intermediate plot.

EXAMPLE 16: The computer-implemented method of any preceding example can be implemented, wherein the separating can comprise: computing, by the device, a first loss between the first ion cloud self-bunching metric and an ideal ion cloud self-bunching metric; labeling, by the device, the first location in the operational parameter space as valid, in response to the first loss falling below a threshold value; and labeling, by the device, the first location in the operational parameter space as invalid, in response to the first loss exceeding the threshold value.

EXAMPLE 17: The computer-implemented method of any preceding example can be implemented, wherein the mass analyzer can belong to a Fourier transform mass spectrometer.

EXAMPLE 18: The computer-implemented method of any preceding example can be implemented, wherein the operational parameter space can comprise: one or more electrode voltage parameters of the mass analyzer; or one or more timing parameters of the mass analyzer.

In various embodiments, any combination or combinations of examples 10-18 can be implemented.

EXAMPLE 19: A computer program product for facilitating mass analyzer evaluation via self-bunching computation can comprise a non-transitory computer-readable memory having program instructions embodied therewith. In various aspects, the program instructions can be executable by a processor to cause the processor to: access a mass analyzer; and separate an operational parameter space of the mass analyzer into a valid region and an invalid region, based on computing ion cloud self-bunching metrics at respective locations in the operational parameter space.

EXAMPLE 20: The computer program product of any preceding example can be implemented, wherein the program instructions are executable to cause the processor to: perform a calibration protocol on the mass analyzer within the valid region and not within the invalid region.

In various embodiments, any combination or combinations of examples 19-20 can be implemented.

In various embodiments, any combination or combinations of examples 1-20 can be implemented.

What is claimed is:

1. A system, comprising:
a processor that executes computer-executable components stored in a non-transitory computer-readable memory, wherein the computer-executable components comprise:
an access component that accesses a mass analyzer; and
a bunching component that separates an operational parameter space of the mass analyzer into a valid region and an invalid region, based on computing ion cloud self-bunching metrics at respective locations in the operational parameter space.

2. The system of claim 1, wherein the computer-executable components comprise:
an execution component that performs a calibration protocol on the mass analyzer within the valid region and not within the invalid region.

3. The system of claim 1, wherein the computer-executable components comprise:
an execution component that generates an alert in response to the valid region not matching a ground-truth valid region or in response to the invalid region not matching a ground-truth invalid region, wherein the alert indicates that a manufacturing or supply change associated with the mass analyzer was not successful.

4. The system of claim 1, wherein, for a first location within the operational parameter space, the bunching component causes the mass analyzer to perform a scan, thereby yielding a first mass spectrum that shows relative ion abundance as a function of mass-to-charge ratio.

5. The system of claim 4, wherein, for each peak in the first mass spectrum, the bunching component computes a respective ion cloud decay rate or proxy thereof and a respective ion population or proxy thereof, thereby yielding a first intermediate plot.

6. The system of claim 5, wherein the bunching component identifies a first ion cloud self-bunching metric for the first location in the operational parameter space, based on fitting an exponential plateau function to the first intermediate plot.

7. The system of claim 6, wherein the bunching component:
computes a first loss between the first ion cloud self-bunching metric and an ideal ion cloud self-bunching metric;
labels the first location in the operational parameter space as valid, in response to the first loss falling below a threshold value; and
labels the first location in the operational parameter space as invalid, in response to the first loss exceeding the threshold value.

8. The system of claim 1, wherein the mass analyzer belongs to a Fourier transform mass spectrometer.

9. The system of claim 1, wherein the operational parameter space comprises: one or more electrode voltage parameters of the mass analyzer; or one or more timing parameters of the mass analyzer.

10. A computer-implemented method, comprising:
accessing, by a device operatively coupled to a processor, a mass analyzer; and
separating, by the device, an operational parameter space of the mass analyzer into a valid region and an invalid region, based on computing ion cloud self-bunching metrics at respective locations in the operational parameter space.

11. The computer-implemented method of claim 10, further comprising:
performing, by the device, a calibration protocol on the mass analyzer within the valid region and not within the invalid region.

12. The computer-implemented method of claim 10, further comprising:
generating, by the device, an alert in response to the valid region not matching a ground-truth valid region or in response to the invalid region not matching a ground-truth invalid region, wherein the alert indicates that a manufacturing or supply change associated with the mass analyzer was not successful.

13. The computer-implemented method of claim 10, wherein the separating comprises:
causing, by the device and for a first location within the operational parameter space, the mass analyzer to perform a scan, thereby yielding a first mass spectrum that shows relative ion abundance as a function of mass-to-charge ratio.

14. The computer-implemented method of claim 13, wherein the separating comprises:
computing, by the device and for each peak in the first mass spectrum, a respective ion cloud decay rate or proxy thereof and a respective ion population or proxy thereof, thereby yielding a first intermediate plot.

15. The computer-implemented method of claim 14, wherein the separating comprises:
identifying, by the device, a first ion cloud self-bunching metric for the first location in the operational parameter space, based on fitting an exponential plateau function to the first intermediate plot.

16. The computer-implemented method of claim 15, wherein the separating comprises:
computing, by the device, a first loss between the first ion cloud self-bunching metric and an ideal ion cloud self-bunching metric;
labeling, by the device, the first location in the operational parameter space as valid, in response to the first loss falling below a threshold value; and
labeling, by the device, the first location in the operational parameter space as invalid, in response to the first loss exceeding the threshold value.

17. The computer-implemented method of claim 10, wherein the mass analyzer belongs to a Fourier transform mass spectrometer.

18. The computer-implemented method of claim 10, wherein the operational parameter space comprises: one or more electrode voltage parameters of the mass analyzer; or one or more timing parameters of the mass analyzer.

19. A computer program product for facilitating mass analyzer evaluation via self-bunching computation, the computer program product comprising a non-transitory computer-readable memory having program instructions embodied therewith, the program instructions executable by a processor to cause the processor to:
access a mass analyzer; and
separate an operational parameter space of the mass analyzer into a valid region and an invalid region, based on computing ion cloud self-bunching metrics at respective locations in the operational parameter space.

20. The computer program product of claim 19, wherein the program instructions are executable to cause the processor to:
perform a calibration protocol on the mass analyzer within the valid region and not within the invalid region.
